(19) United States
(12) Patent Application Publication
(10) Pub. No.: US 2022/0335048 A1
(43) Pub. Date: Oct. 20, 2022

(54) ELECTRONIC CONTENT MANAGEMENT AND SHARING PLATFORM UTILIZING COORDINATED DISTRIBUTED SEMI-AUTONOMOUS NODES

(71) Applicant: LEARNINGBASE PTY. LTD., Victoria (AU)

(72) Inventors: Donald Peter FEAVER, Victoria (AU); I Made SURYAWAN, Bali (ID); Jarrad Ross MERLO, Victoria (AU)

(21) Appl. No.: 17/640,539

(22) PCT Filed: Sep. 4, 2020
(86) PCT No.: PCT/IB2020/058273

§ 371 Date: Mar. 4, 2022

Related U.S. Application Data
(60) Provisional application No. 62/896,665, filed on Sep. 6, 2019.

(51) Int. Cl. G06F 16/2457; G06F 16/27; G06F 16/2453

(52) U.S. Cl. CPC G06F 16/24573; G06F 16/27; G06F 16/2453

(57) ABSTRACT

Various embodiments of the present disclosure are directed to improved systems, apparatuses, methods, and computer program products for management, transfer, and traceability of node content between semi-autonomous nodes communicable with a hub node configured to register user nodes and facilitate communications between the registered user nodes. An apparatus may be configured to receive a hub registration request from a first user node, register the first user node, receiving a second hub registration request from a second user node, register the second user node, receive a node connection request, transmit the node connection request to the second user node, receive a node connection response from the second user node, transmit the node connection response to the first user node, generate a node connection report based on the node connection request, the node connection response, or a combination thereof, and cause storing of the node connection report in a ledger.

### TECHNOLOGICAL FIELD

Example embodiments of the present disclosure relate generally to management, sharing, and distribution of electronically managed content, and more specifically, to systems, apparatuses, methods, and computer program products for content management and distribution through distributed semi-autonomous user nodes in communication with a hub node.

### BACKGROUND

The inventors have discovered problems with existing platforms for electronic content management and distribution. Through applied effort, ingenuity, and innovation, the inventors have solved many of these identified problems by developing solutions embodied by the present disclosure and described in detail below.

### BRIEF SUMMARY

In some examples, content sharing and management between multiple entities is crucial in facilitating an optimal environment for utilizing such content. For example, in a learning environment, activities created by an entity preferably are shareable with another entity for use. Furthermore, tracing the source of shared content is desirable, for example in instances where learning-based content is shared from a creator, shared from a third-party, or edited. By tracing the source of shared content, a rightful owner can be determined for a given piece of content. However, due to the system architecture and technical limitations associated with many platforms, said platforms often do not or cannot perform these operations in a robust and/or scalable manner.

Methods, apparatuses, and systems are described herein that facilitate improved content management (e.g., creation and/or editing of electronically managed content) and improved sharing of content between entities via user nodes configured to communicate with one another in addition to communicating with a hub node. In this regard, example embodiments utilize a hub node to coordinate communications between a plurality of user nodes, as well as to facilitate auditing of content transfer, and ownership and/or attribution of content contributions performed by the various user nodes.

One embodiment is directed to a computer-implemented method for enabling node content management between two user nodes of a user node set with attribution and traceability. The method includes receiving a hub registration request from a first user node of the user node set; registering the first user node of the user node set to a registered node list; receiving a second hub registration request from a second user node of the user node set; registering the second user node of the user node set to the registered node list; receiving a node connection request from the first user node; transmitting the node connection request to the second user node; receiving a node connection response from the second user node; transmitting the node connection response to the first user node; generating a node connection report based on the node connection request, the node connection response, or a combination thereof; and causing storing of the node connection report in a ledger configured to store at least the node connection report.

In some embodiments, the method further includes receiving a node content request from a target user node associated with a source user node, the node content request associated with requested original node content, wherein the target user node is the first user node or the second user node, and the target user node is the other of the first user node or the second user node; relaying the node content request to the source user node; receiving a node content response from the source user node, wherein the node content response comprises a node content duplicate associated with the requested original node content; relaying the node content response to the target user node to cause the target user node to store the node content duplicate; generating a node content transfer report based on the node content request, the node content response, or the combination thereof; and storing the node content transfer report in the ledger.

In some embodiments, the method further includes receiving an editing metadata set from the target user node or the source user node, the editing metadata set associated with edited node content generated from source node content; generating a node content edit report based on at least the editing metadata set; and storing the node content edit report in the ledger.

In some embodiments, the method further includes receiving a node content generation metadata set from the target user node or the source user node, the node content generation metadata set associated with new created node content; generating a node content generation report based on at least the node content generation metadata set; and storing the node content generation report in the ledger.

In some embodiments, the method further includes identifying a transferred content checksum associated with the node content duplicate; identifying a source content checksum associated with the requested original node content; and determining the transferred content checksum matches the source content checksum by comparing the transferred content checksum and the source content checksum, wherein relaying the node content response is in response to the determination the transferred content checksum matches the source content checksum.

In some embodiments, the method further includes retrieving, from the ledger, a node content report set based on the node content request and the node content response, the node content report set comprising a node content generation report set, a node content edit report set, a node content transfer report set, or a combination thereof; and validating an attribution chain associated with the node content report set is complete, wherein relaying the node content response is in response to validating the attribution chain.

In some embodiments, the method further includes retrieving, from the ledger, a node content report set based on the editing metadata set and the node content response, the node content report set comprising a node content generation report set, a node content edit report set, a node content transfer report set, or a combination thereof; and validating an attribution chain associated with the node content report set is complete, wherein storing the node content edit report in the ledger is in response to validating the attribution chain.

Another embodiment is directed to an apparatus for node content management between two user nodes of a user node set with attribution and traceability, the apparatus comprising at least one processor and at least one memory. The apparatus includes at least one memory with computer-coded instructions therein, the computer-coded instructions configured to, in execution with the at least one processor, cause the apparatus to: receive a hub registration request from a first user node of the user node set; register the first user node of the user node set to a registered node list; receive a second hub registration request from a second user node of the user node set; register the second user node of the user node set to the registered node list; receive a node connection request from the first user node; transmit the node connection request to the second user node; receive a node connection response from the second user node; transmit the node connection response to the first user node; generate a node connection report based on the node connection request, the node connection response, or a combination thereof; and cause storing of the node connection report in a ledger configured to store at least the node connection report.

In some embodiments, the apparatus is further configured to receive a node content request from a target user node associated with a source user node, the node content request associated with requested original node content, wherein the target user node is the first user node or the second user node, and the target user node is the other of the first user node or the second user node; relay the node content request to the source user node; receive a node content response from the source user node, wherein the node content response comprises a node content duplicate associated with the requested original node content; relay the node content response to the target user node to cause the target user node to store the node content duplicate; generate a node content transfer report based on the node content request, the node content response, or the combination thereof; and store the node content transfer report in the ledger.

In some embodiments, the apparatus is further configured to receive an editing metadata set from the target user node or the source user node, the editing metadata set associated with edited node content generated from source node content; generate a node content edit report based on at least the editing metadata set; and store the node content edit report in the ledger.

In some embodiments, the apparatus is further configured to receive a node content generation metadata set from the target user node or the source user node, the node content generation metadata set associated with new created node content; generate a node content generation report based on at least the node content generation metadata set; and store the node content generation report in the ledger.

In some embodiments, the apparatus is further configured to identify a transferred content checksum associated with the node content duplicate; identify a source content checksum associated with the requested original node content; and determine the transferred content checksum matches the source content checksum by comparing the transferred content checksum and the source content checksum, wherein the apparatus is configured to relay the node content response in response to the determination the transferred content checksum matches the source content checksum.

In some embodiments, the apparatus is further configured to retrieve, from the ledger, a node content report set based on the node content request and the node content response, the node content report set comprising a node content generation report set, a node content edit report set, a node content transfer report set, or a combination thereof; and validate an attribution chain associated with the node content report set is complete, wherein the apparatus is configured to relay the node content response is in response to validating the attribution chain.

In some embodiments, the apparatus is further configured to retrieve, from the ledger, a node content report set based on the editing metadata set and the node content response, the node content report set comprising a node content generation report set, a node content edit report set, a node content transfer report set, or a combination thereof; and validate an attribution chain associated with the node content report set is complete, wherein the apparatus is configured to store the node content edit report in the ledger in response to validating the attribution chain.

Another embodiment is directed to a computer program product for node content management between two user nodes of a user node set with attribution and traceability, the computer program product comprising at least one non-transitory computer readable storage medium having computer program instructions stored therein, the computer program instructions configured to, when executed by a processor, cause the processor to: receive a hub registration request from a first user node of the user node set; register the first user node of the user node set to a registered node list; receive a second hub registration request from a second user node of the user node set; register the second user node of the user node set to the registered node list; receive a node connection request from the first user node; transmit the node connection request to the second user node; receive a node connection response from the second user node; transmit the node connection response to the first user node; generate a node connection report based on the node connection request, the node connection response, or a combination thereof; and cause storing of the node connection report in a ledger configured to store at least the node connection report.

In some embodiments, the computer program product is further configured to receive a node content request from a target user node associated with a source user node, the node content request associated with requested original node content, wherein the target user node is the first user node or the second user node, and the target user node is the other of the first user node or the second user node; relay the node content request to the source user node; receive a node content response from the source user node, wherein the node content response comprises a node content duplicate associated with the requested original node content; relay the node content response to the target user node to cause the target user node to store the node content duplicate; generate a node content transfer report based on the node content request, the node content response, or the combination thereof; and store the node content transfer report in the ledger.

In some embodiments, the computer program product is further configured to receive an editing metadata set from the target user node or the source user node, the editing metadata set associated with edited node content generated from source node content; generate a node content edit report based on at least the editing metadata set; and store the node content edit report in the ledger.

In some embodiments, the computer program product is further configured to receive a node content generation metadata set from the target user node or the source user node, the node content generation metadata set associated with new created node content; generate a node content generation report based on at least the node content generation metadata set; and store the node content generation report in the ledger.

In some embodiments, the computer program product is further configured to identify a transferred content checksum associated with the node content duplicate; identify a source content checksum associated with the requested original node content; and determine the transferred content checksum matches the source content checksum by comparing the transferred content checksum and the source content checksum, wherein the processor is configured to relay the node content response in response to the determination the transferred content checksum matches the source content checksum.

In some embodiments, the computer program product is further configured to retrieve, from the ledger, a node content report set based on the node content request and the node content response, the node content report set comprising a node content generation report set, a node content edit report set, a node content transfer report set, or a combination thereof; and validate an attribution chain associated with the node content report set is complete, wherein the processor is configured to relay the node content response is in response to validating the attribution chain.

In some embodiments, the computer program product is further configured to retrieve, from the ledger, a node content report set based on the editing metadata set and the node content response, the node content report set comprising a node content generation report set, a node content edit report set, a node content transfer report set, or a combination thereof; and validate an attribution chain associated with the node content report set is complete, wherein the apparatus is configured to store the node content edit report in the ledger in response to validating the attribution chain.

Another embodiment is directed to a computer-implemented method for transferring node content from a source user node to a target user node. The computer-implemented method comprises registering to a hub node utilizing a hub registration process; connecting to a target user node utilizing a node connection process; receiving, from the target user node, a node content request comprising at least a node content identifier; retrieving, from a source user node content storage, node content associated with a first content identifier; generating a node content duplicate using the node content; causing storage of the node content duplicate in a target user node content storage, the node content duplicate stored associated with a second content identifier; identifying a permission set, wherein the permission set is associated with the node content duplicate; causing transmission to the hub node of a node content transfer report; and causing, on the hub node, storage of the node content transfer report in a node content transfer report ledger.

Another embodiment is directed to an apparatus for transferring node content from a source user node to a target user node, the apparatus comprising at least one processor and at least one memory, the at least one memory with computer-coded instructions therein, the computer-coded instructions configured to, in execution with the at least one processor, cause the apparatus to: register to a hub node utilizing a hub registration process; connect to a target user node utilizing a node connection process; receive, from the target user node, a node content request comprising at least a node content identifier; retrieve, from a source user node content storage, node content associated with a first content identifier; generate a node content duplicate using the node content; cause storage of the node content duplicate in a target user node content storage, the node content duplicate stored associated with a second content identifier; identify a permission set, wherein the permission set is associated with the node content duplicate; cause transmission to the hub node of a node content transfer report; and cause, on the hub node, storage of the node content transfer report in a node content transfer report ledger.

Another embodiment is directed to a computer program product for transferring node content from a source user node to a target user node, the computer program product comprising at least one non-transitory computer readable storage medium having computer program instructions stored therein, the computer program instructions configured to, when executed by a processor, cause the processor to: register to a hub node utilizing a hub registration process; connect to a target user node utilizing a node connection process; receive, from the target user node, a node content request comprising at least a node content identifier; retrieve, from a source user node content storage, node content associated with a first content identifier; generate a node content duplicate using the node content; cause storage of the node content duplicate in a target user node content storage, the node content duplicate stored associated with a second content identifier; identify a permission set, wherein the permission set is associated with the node content duplicate; cause transmission to the hub node of a node content transfer report; and cause, on the hub node, storage of the node content transfer report in a node content transfer report ledger.

Another embodiment is directed to a computer program product for receiving node content from a user node, the method comprising: registering to a hub node utilizing a hub registration process; connecting to a source node utilizing a node connection process; transmitting, to the source node, a node content request comprising at least a node content identifier; receiving, from the source node, a node content response including a node content duplicate; generating a node content identifier that uniquely identifies the node content duplicate; storing, in a node content storage, the node content duplicate associated with the generated node content identifier; and causing transmission to the hub node of a node content transfer report.

Another embodiment is directed to an apparatus for receiving node content from a user node, the apparatus comprising at least one processor and at least one memory, the at least one memory with computer-coded instructions therein, the computer-coded instructions configured to, in execution with the at least one processor, cause the apparatus to: register to a hub node utilizing a hub registration process; connect to a source node utilizing a node connection process; transmit, to the source node, a node content request comprising at least a node content identifier; receive, from the source node, a node content response including a node content duplicate; generate a node content identifier that uniquely identifies the node content duplicate; store, in a node content storage, the node content duplicate associated with the generated node content identifier; and cause transmission to the hub node of a node content transfer report.

Another embodiment is directed to a computer program product for receiving node content from a user node, the computer program product comprising at least one non-transitory computer readable storage medium having computer program instructions stored therein, the computer program instructions configured to, when executed by a processor, cause the processor to: register to a hub node utilizing a hub registration process; connect to a source node utilizing a node connection process; transmit, to the source node, a node content request comprising at least a node content identifier; receive, from the source node, a node content response including a node content duplicate; generate a node content identifier that uniquely identifies the node content duplicate; store, in a node content storage, the node content duplicate associated with the generated node content identifier; and cause transmission to the hub node of a node content transfer report.

Another embodiment is directed to a computer-implemented method for tracing node content transferred between a source user node and a target user node, the method comprising: receiving a source user node hub registration request from a source user node, the source user node hub registration request comprising at least a source user node metadata set associated with the source user node; storing the source user node metadata set in a registered node list; receiving a target user node hub registration request from a target user node, the target user node hub registration request comprising at least a target user node metadata set associated with the target user node; storing the target user node metadata set in the registered node list; causing connection between the target user node and the source user node; receiving a node content transfer report associated with a transfer of node content between the source user node and the target user node; and storing at least a portion of the node content transfer report in a node content transfer report ledger.

Another embodiment is directed to an apparatus for tracing node content transferred between a source user node and a target user node, the apparatus comprising at least one processor and at least one memory, the at least one memory with computer-coded instructions therein, the computer-coded instructions configured to, in execution with the at least one processor, cause the apparatus to: receive a source user node hub registration request from a source user node, the source user node hub registration request comprising at least a source user node metadata set associated with the source user node; store the source user node metadata set in a registered node list; receive a target user node hub registration request from a target user node, the target user node hub registration request comprising at least a target user node metadata set associated with the target user node; store the target user node metadata set in the registered node list; cause connection between the target user node and the source user node; receive a node content transfer report associated with a transfer of node content between the source user node and the target user node; and store at least a portion of the node content transfer report in a node content transfer report ledger.

Another embodiment is directed to a computer program product for tracing node content transferred between a source user node and a target user node, the computer program product comprising at least one non-transitory computer readable storage medium having computer program instructions stored therein, the computer program instructions configured to, when executed by a processor, cause the processor to: receive a source user node hub registration request from a source user node, the source user node hub registration request comprising at least a source user node metadata set associated with the source user node; store the source user node metadata set in a registered node list; receive a target user node hub registration request from a target user node, the target user node hub registration request comprising at least a target user node metadata set associated with the target user node; store the target user node metadata set in the registered node list; cause connection between the target user node and the source user node; receive a node content transfer report associated with a transfer of node content between the source user node and the target user node; and store at least a portion of the node content transfer report in a node content transfer report ledger.

Another embodiment is directed to a computer-implemented method for editing node content with traceability, the method comprising: registering to a hub node utilizing a hub registration process; connecting to a target user node utilizing a node connection process; retrieving, from a user node content storage, source node content associated with a source node content identifier; generating, utilizing the source node content, edited node content; generating an edited node content identifier; storing, in the user node content storage, the edited node content associated with the edited node content identifier; transmitting, to the hub node, a node content edit report; and causing, on the hub node, storage of the node content edit report in a node content edit report ledger.

Another embodiment is directed to an apparatus for editing node content with traceability, the apparatus comprising at least one processor and at least one memory, the at least one memory with computer-coded instructions therein, the computer-coded instructions configured to, in execution with the at least one processor, cause the apparatus to: register to a hub node utilizing a hub registration process; connect to a target user node utilizing a node connection process; retrieve, from a user node content storage, source node content associated with a source node content identifier; generate, utilizing the source node content, edited node content; generate an edited node content identifier; store, in the user node content storage, the edited node content associated with the edited node content identifier; transmit, to the hub node, a node content edit report; and cause, on the hub node, storage of the node content edit report in a node content edit report ledger.

Another embodiment is directed to a computer program product for receiving node content from a user node, the computer program product comprising at least one non-transitory computer readable storage medium having computer program instructions stored therein, the computer program instructions configured to, when executed by a processor, cause the processor to: register to a hub node utilizing a hub registration process; connect to a target user node utilizing a node connection process; retrieve, from a user node content storage, source node content associated with a source node content identifier; generate, utilizing the source node content, edited node content; generate an edited node content identifier; store, in the user node content storage, the edited node content associated with the edited node content identifier; transmit, to the hub node, a node content edit report; and cause, on the hub node, storage of the node content edit report in a node content edit report ledger.

Another embodiment is directed to a computer-implemented method for enabling traceability of node content edited by a user node, the method comprising: receiving a user node hub registration request from a user node, the user node hub registration request comprising at least a user node metadata set associated with the user node; storing the user node metadata set in a registered node list; receiving a node content edit report; and storing at least a portion of the node content edit report in a node content edit report ledger.

Another embodiment is directed to an apparatus for enabling traceability of node content edited by a user node, the apparatus comprising at least one processor and at least one memory, the at least one memory with computer-coded instructions therein, the computer-coded instructions configured to, in execution with the at least one processor, cause the apparatus to: receive a user node hub registration request from a user node, the user node hub registration request comprising at least a user node metadata set associated with the user node; store the user node metadata set in a registered node list; receive a node content edit report; and store at least a portion of the node content edit report in a node content edit report ledger.

Another embodiment is directed to a computer program product for enabling traceability of node content edited by a user node, the computer program product comprising at least one non-transitory computer readable storage medium having computer program instructions stored therein, the computer program instructions configured to, when executed by a processor, cause the processor to: receive a user node hub registration request from a user node, the user node hub registration request comprising at least a user node metadata set associated with the user node; store the user node metadata set in a registered node list; receive a node content edit report; and store at least a portion of the node content edit report in a node content edit report ledger.

### BRIEF DESCRIPTION OF THE DRAWINGS

Having described certain example embodiments of the present disclosure in general terms above, reference will now be made to the accompanying drawings, which are not necessarily drawn to scale.

FIG. 1 illustrates an example system in which embodiments of the present disclosure may operate.

FIG. 2 illustrates a schematic block diagram of example circuitry embodying a hub apparatus that may perform operations in accordance with some example embodiments described herein.

FIG. 3 illustrates a schematic block diagram of example circuitry embodying a node apparatus that may perform operations in accordance with some example embodiments described herein.

FIG. 4 illustrates an example metadata dictionary used by some embodiments of the present disclosure in operations described herein.

FIG. 5 illustrates a flowchart depicting operations of an example process for configuring, via a hub node, a user node for communication with other user nodes in accordance with some example embodiments described herein.

FIG. 6 illustrates a flowchart depicting an example process for configuring, via a hub node, two user nodes for communication in accordance with some example embodiments described herein.

FIG. 7A illustrates an example system and data flow in which embodiments of the present disclosure may operate for tracing, via a hub node, content transfers between two connected user nodes in accordance with some example embodiments described herein.

FIG. 7B illustrates a flowchart depicting operations of an example process for tracing, via a hub node, content transfers between two connected user nodes in accordance with some example embodiments described herein.

FIG. 8A illustrates an example system and data flow in which embodiments of the present disclosure may operate for editing content on a user node utilize a hub node to facilitate tracing of content edits in accordance with embodiments described herein.

FIG. 8B illustrates a flowchart depicting operations of an example process for editing content on a user node utilizing a hub node to facilitate tracing of content edits in accordance with example embodiments described herein.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein. Rather, these embodiments are provided so that this disclosure will satisfy applicable legal requirements. Like numbers refer to like elements throughout.

### Overview

Systems, devices, platforms, and the like for creating and distributing electronically managed content often aim to achieve multiple goals. For example, content generation platforms may provide tools for creating electronically managed content and storing the created content. Various tools may enable generation of such electronically managed content from different sources, for example some electronically managed content may be originally generated without using any source material, while other electronically managed content may be generated or otherwise derived from editing existing content to add, delete, or change material. Such platforms may advantageously, in some examples, provide distribution functionality and/or tools, to operate as a distribution platform as well, and/or communicate with a distribution platform, for enabling sharing of electronically managed content between various users.

Distribution platforms may be designed to enable sharing between various users. In this regard, such platforms may provide tools and functionality that enable users to share content that they have generated or otherwise accessed with other users. However, such unfettered sharing comes at the expense of traceability and attribution. For example, without appropriate configuration and tracking, the original creator of electronically managed content may be unascertainable as electronically managed content is distributed via a distribution platform. Indeed, as content continues to be transferred via the distribution platform, it may become increasingly difficult to determine who the original creator of such electronically managed content and/or who owns rights to the content.

Such problems are further exacerbated in combination with current example content generation tools and/or platform(s). Shared electronically managed content may be generated from a user and transferred to other users that may further edit the content, such as by adding or changing some or all of the electronically managed content. Traceability and attribution of such new and/or changed content may also be unascertainable without appropriate configuration. For example, it may be unclear what user(s) receives attribution for derived electronically managed content.

Often, such platforms are configured to provide the same functionality and/or tools to each user. Additionally, users in such platforms leverage a single, centralized database for storing the electronically managed content. Further, each user often accesses this same centralized database for purposes of identifying content for sharing and/or storing content additions or edits.

One example context of such a platform is an e-educational platform configured for sharing e-educational content. Such platforms often may provide a shared, common set of functionality to users for creating e-educational content. Such platforms often also maintain e-educational content in a single, centralized database that is accessible by each user of the platform. Users may opt to retrieve e-educational content stored in the centralized database, which then may allow the user to utilize the content and/or edit the content. The platform often may further provide a shared, common set of functionality for e-educational content retrieved from the centralized database.

However, the operations of such platforms are deficient in many regards. The shared, common set of functionality for creating and/or editing e-educational content subjects prevents users from customizing their usage of the platform. In instances where a user desires certain particular limited functionality, and/or wishes to the extend functionality of the platform, the platform may prevent the user from doing so.

Further, in some examples, every user of the platform may rely on the centralized database for e-educational content management and distribution. The user may trust the platform to manage its content as desired, as the platform functions as a controller for carrying out the distribution and storage of e-educational content. Similarly, the platform must be trusted to manage user edits to e-educational content, as well as attribution and ownership tracing of such edited e-educational content. in some examples, current platforms are often not properly configured to perform such actions and in instances where platforms utilize the centralized database for such actions, the centralized database is often inefficient and/or ineffective at providing attribution and/or ownership traceability of such edited content.

Various embodiments of the present invention relate to a platform that comprises functionality for creating, managing, and/or distributing node content via an eco-system comprising semi-autonomous user nodes and a hub node. Embodiments of the present disclosure are thus provided for creating, managing, and/or distributing node content. Embodiments of the present disclosure may be embodied by an apparatus, system, computer-program product, or computer-implemented process, or a combination thereof.

In an example context, the eco-system of nodes forms a system for creating, editing, transmitting, and managing distribution and performance of e-educational content. For example, each user node may be used by administrator users associated with administrator user accounts, for example instructors of a class, to create activity data objects and course data objects, and student users associated with student user accounts for registering for and accessing a course. The course data objects may represent a particular set of activity data objects, which may be assignments due throughout the course facilitated by one or more administrator (or instructor) users. Via the user node, the student user may be able to submit various electronic documents associated with activity data objects, communicate with the instructor user or other student users, attend lectures or view lecture schedules, or access and/or view other data associated with a course.

In some embodiments, the hub node may facilitate some or all of this functionality, or may enhance this functionality by analyzing data that flows through the hub node or is stored in one or more reports by the hub node. For example, the hub node may analyze various student performance data, submission data, scheduling data, and/or other data accessible to the hub node to predict the likelihood that each user will fall behind or perform poorly in one or more courses associated with the user (e.g., the course data object is associated with a student user account such that the student user account is indicated as enrolled in the course). To make predictions, the hub node may use various algorithmic, statistical, or machine learning model implementations. The hub node may make predictions based on data associated with a particular user, data associated with a particular course data object, data associated with a subset of users associated with a course data object (e.g., a particular class of users), or all user data associated with multiple courses and/or even multiple user nodes. Additionally, the hub node may prompt a user node to perform one or more actions based on these predictions. For example, the hub node may prompt the user node to suggest and/or facilitate scheduling a meeting between a struggling student user and a course instructor. Alternatively, the hub node may alert, or cause a user node to alert, a particular student user about their performance when falling behind, such as by transmitting alert information.

An example eco-system in accordance with the example embodiments of the present disclosure includes semi-autonomous user nodes. Each semi-autonomous user node may be fully autonomous regarding functionality for creating and/or editing node content. In other words, without the control of a central server or platform, each user node may be capable of storing node content accessible to the user node, for example in a local datastore, and editing the stored node content to create and store edited node content. Additionally or alternatively, each user node may be configured to enable generation of node content for storage via the user node.

Each user node instance is, in some example embodiments, independent and configurable by a user accessing the user node, for example via a user device. Each user node may control a local, or locally-controlled, datastore for storing node content associated with the user node, such that reliance on a central database is not required for accessing stored node content.

Additionally, each user node may be configured to provide different functionality. For example, a user node may be configured to provide functionality by configuring modules, such as software modules configured to operate via the user node. A user accessing a particular user node may install, and/or configure, the user node to provide functionality associated with a particular set of modules. Each user node instance may conserve processing and/or data storage resources by minimizing the functionality provided via each user node to only that which the users of the node request. In this manner, each user node may be configured to provide functionality unique or substantially unique to each instance, such that if only certain functionality is required or requested, but not other functionality (e.g., content creation functionality is required but not editing and/or sharing functionality), the user node may be specifically configured to enable this without allocating computing resources to unnecessary and/or undesired functionality.

In addition to the fully-autonomous functionality controlled entirely by a single user node, each user node may be semi-autonomous in that the user node may further be configured to communicate utilizing connections facilitated by a hub node. The hub node may be configured to enable connection provisioning between user node instances, functioning as a linking mechanism between the semi-autonomous user nodes. The hub node may be configured to store user node identification information and connection information and/or metadata to facilitate connections between the various user nodes. In this regard, a user node may register with the hub node, enabling the hub node to allow other registered user nodes to identify the newly registered user node. The hub node may manage and store the provided user node information and provide each registered user node with required information for connecting to each other registered user node. By maintaining and providing user node information, the hub node enables each registered user node to discover and communicate directly with other registered user nodes.

Once a user node registers and receives information for connecting to another registered user node, the user node may store such information or store information associated with registered user nodes. Alternatively, the user node may utilize the received information to request connection to another user node via the hub node, or utilize a previously connection to transfer node content, including real-time communicated content and/or scheduling content, to the substantively connected node.

User nodes may request connection to a second user node to view and/or share data. For example, a user of a first user node may directly request connection to a second user node to browse node content stored by the second user node, and request node content that may be of interest to the user.

Each registered user node may provide a myriad of functionality that involves communicating with another registered user node. For example, a user of a first user node may, directly or indirectly via a hub node, communicate with a second user node with which the first user node is substantively connected to browse and/or request e-educational materials stored by the second user node, such as courses and/or activities packaged and stored as electronically managed data objects. Additionally or alternatively, for example, a first user node may exchange content licensing business rules data objects, student performance metric data object, and/or real-time communications, including video, audio, and text communications.

The hub node may also function as an auditor of content creation and transactions and/or sharing between user nodes. For example, when creating and/or editing node content, the user node may provide information to the hub node to memorialize that the created node content is associated with the user node. Similarly, during and/or upon completion of a transaction of node content, the transacting user nodes may work together to provide the hub node with metadata associated with the transaction and/or transacting user nodes. The hub node may synthesize received information and/or store it for future auditing, including for traceability and attribution of node content as it is created and/or transferred.

The hub node may also store the received metadata sets such that the information may be audited by one or more devices associated with the hub node, for example the user nodes or designated auditing nodes. In some embodiments, a received metadata set, for example associated with created, edited, and/or transferred node content, may be stored in a custom blockchain storage. The custom blockchain storage, in some embodiments, is configured to ensure immutability of the stored information without risk of retroactive manipulation by the hub node or one or more user nodes. In various embodiments, the custom blockchain storage may include one or more blockchains configured to store information associated with the various types of node content and/or communication. In this regard, a custom blockchain storage may be configured as a public blockchain, private blockchain, hybrid blockchain, or a combination thereof based on the type of information being stored. In some embodiments, the custom blockchain storage may be configured based on various sharing and/or record log recording rules.

Embodiments of the present disclosure provide important technical advantages in node content creation, storage, and distribution. Each user node may be fully customized to enable access to particular functionality, thus minimizing or eliminating computing resource waste dedicated towards unneeded and/or unused functionality. Additionally, in some embodiments, the semi-autonomous nature of a user node enables the user node to be used regardless of network connectivity, network fidelity, and/or network capabilities. In embodiments where one or more user nodes may connect to a hub node, the user nodes remain semi-autonomous in that the user nodes can perform one or more fully autonomous functions uniquely configured associated with the user node. User nodes may create and/or edit node content without requiring coordination with a centralized server, improving overall system efficiency and minimizing network resource usage without sacrificing traceability. Further, the user nodes in such embodiments are not dependent on the hub node, or any centralized node, to perform transfers and/or other functionality associated with communicating with peer user nodes.

In example configurations utilizing the hub node, the hub node may generate and/or store reports of node content creating, editing, and/or transferring. By generating and/or storing the reports associated with each of these actions, the hub node uniquely enables traceability, ownership, and other auditing capabilities of such node content as it is accessed. In this regard, in such example embodiments, the user nodes function with improved processing capabilities and/or computing resource allocation as compared to conventional systems, while the eco-system enables efficient and effective storage and auditing of reports and/or metadata sets memorializing node content creation, edits, and/or transfers.

The hub node may receive, store, and/or analyze the data relayed through the hub node or included in the various reports.

### Definitions

The term “user” refers to any entity, individual, company, or the like. In some embodiments, identifying information is associated with a user. For example, an individual, entity, company, or the like may be associated with a name (e.g., a first and last name or a company/entity name), email, contact phone number, and/or the like. A user, as described herein, accesses a user node associated with the user via a “user device,” which refers to any number of known electronic computing devices for communicating with another device over a wired connection and/or network. Examples of a user device include, without limitation, a personal computer, laptop, mobile device, tablet device, personal digital assistant, wearable device, and customized communication device including processing and communication functionality.

The term “node content” refers to user generated information stored by a user node configured to store, transfer, and/or edit the user generated information. In some example embodiments, node content refers to e-educational data managed as electronically stored data objects. For example, in some embodiments, node content includes, without limitation, course content, activity content, communications between users and/or communications between nodes, user course registration details, user performance data (e.g., grade data for an activity and/or course), course workflow task data, activity workflow task data, user activity completion data, user course completion data, and/or files associated with the aforementioned data, such as audio, video, document, and/or image files. In some embodiments, node content refers to a combination of the aforementioned data. In other example embodiments, node content refers to audio-visual content data managed as electronically stored data objects, for example without limitation, video data, audio data, editing data, keyframe data, image data, effects data, or the like. In other example embodiments, node content refers to business content data stored as electronically stored data objects, for example without limitation sales data, task completion data, and/or other shareable data.

The term “course” refers to an electronic data object associated with one or more activity data objects managed by a particular user node. In particular example embodiments, each course may be associated with a particular instructor and/or administrator user that organizes and/or facilitates operation of the course via the user node. Users may enroll, via the user node, as a student in the course. In some example embodiments, the user node is configured to facilitate enrollment by users, distribution of the activities associated with the course, collection and/or grading of such activities, and/or other course administration tasks.

The term “original node content” refers to user content created via one or more tools accessible via a user node without copying in whole from existing node content (e.g., created from scratch via the user node). An example of original node content is user content newly created by a user associated with a user node (for example, when a teacher creates a new course from scratch). Another example of original node content is a newly created edit for addition to existing course content (for example, when a teacher adds a new activity to an existing course duplicated from another user node). Yet another example of original node content is node content generated by compiling existing node content (for example, when a teacher creates a course that includes a first activity duplicated from another user node and a second activity duplicated from another user node, the newly created course is original node content).

The term “edited node content” refers to pre-existing source node content edited via one or more tools accessible via a user node to include original node content and/or existing node content from second source node content. In some example embodiments, different portions of edited node content are attributed to different user nodes and/or users. For example, the source node content may embody a book comprising multiple chapters created by a first user via a first user node, and at least one chapter created by a second user via a second user node.

The term “node content duplicate” refers to a copied version of node content, such that the copied node content and the node content include the same information. In some embodiments, a node content duplicate is sent from a source user node to a target user node, such as in response to a node content request. In some embodiments, a node content duplicate is associated with a permission set that limits use of the node content duplicate for subsequent transfer, licensing, and/or other usage.

The term “node content identifier” refers to information that uniquely identifies particular node content or particular node content duplicate. Accordingly, each node content and node content duplicate has an identifier that is unique compared to other node content and node content duplicates. In some embodiments, a node content identifier may be an alphanumeric string having a particular length (e.g., an alphanumeric string having 32 characters). In some embodiments, a node content identifier is in a universally unique identifier (“UUID”) format. For example, in some embodiments a node content identifier is a 128-bit number, such that a newly generated node content or node content duplicate is unlikely to be associated with an identifier already associated with an existing node content or node content duplicate.

The term “node content storage” refers to a database, ledger, memory storage device, or similar storage medium embodied via hardware and/or software and associated with a particular user node, where the database or similar storage medium is configured to store node content and/or node content duplicates. In some embodiments, a node content storage comprises a first storage for node content and a second storage for node content duplicates. Alternatively, in some embodiments, node content and node content duplicates are stored together in a single node content storage such that the two content types are treated the same. In some embodiments, a node content storage additionally is configured to store a permission set associated with a node content or a node content duplicate.

The term “user node” refers to computer hardware or software apparatus configured to create node content, view node content, transfer node content, and/or edit node content. Additionally, a user node is configured to register with a hub node and connect with one or more other registered user nodes. In some embodiments, a user node is configured to transmit and/or receive a node content request from another user node registered to the hub node. In some embodiments, a user node is configured to transmit and/or receive a node content response from another user node registered to the hub node. In some embodiments a user node is configured to communicate with a hub node to facilitate tracing of content transfers. In some embodiments, a user node is configured to communicate a hub node to facilitate tracing edits to node content.

The term “user node identifier” refers to unique number, alphanumeric code, or other representation that identifies a particular user node. Accordingly, all user nodes have unique user node identifiers. In some embodiments, a user node identifier may be an alphanumeric string having a particular length (e.g., an alphanumeric string having 32 characters). In some embodiments, a user node identifier is in a universally unique identifier (“UUID”) format. For example, in some embodiments a user node identifier is a 128-bit number, such that a newly generated user node identifier is unlikely to have been previously generated by an existing user node.

The term “user node metadata” refers to an information set associated with a user node that includes information for use with identifying the user node. In some embodiments, user node metadata additionally includes information for connecting to, communicating with, and otherwise accessing a user node. For example, in a particular example embodiment, user node metadata includes (1) a unique identifier associated with the user node, such as an identifier in UUID form (2) a URI address associated with the user node (3) an organization name associated with the user node, and/or (4) a contact email address associated with the user node.

The term “hub node” refers to a computer hardware or software apparatus configured to register user nodes utilizing a hub registration process and facilitate connection between registered user nodes. In some embodiments, a hub node is further configured to facilitate tracing of content transfers between registered user nodes. In some embodiments, a hub node is further configured to facilitate tracing of content edits by a user node.

The term “hub registration request” refers to electronic data sent from a user node to a hub node indicating the user node is to be added to a user node list, or user node dictionary, stored on the hub node. A hub registration request may include data useful for registering a user node, for example user node metadata. In some embodiments, in response to receiving a hub registration request, a hub node may perform a hub registration process.

The term “hub registration process” refers to a set of operations performed by a hub node to register a user node such that the hub node may later identify the user node utilizing information transmitted from the user node to the hub node. In some embodiments, a hub registration process includes storing user node metadata in a user node list or a user node dictionary.

The term “node connection process” refers to a set of operations performed by a hub node in conjunction with a first user node and a second user node to connect the first user node and the second user node. For example, in some embodiments, a first node is configured to send a node connection request to a second user node, the second user node sends a node connection response (e.g., a node connection approval or rejection) in response, and both the first user node and the second user node update their corresponding connection database to reflect the new connection to the other node if approved. In some embodiments, one or both of the user nodes communicate with a hub node to report the connection. In some embodiments, a different node connection process connects the user nodes indirectly via a hub node. For example, in some embodiments, a first user node transmits a node connection request to a hub node that is relayed via the hub node to a second user node, and the second user node transmits a node connection response (e.g., a node connection approval or rejection) to the hub node in response, which is relayed via the hub node to the first user node. If approved, the user nodes may update their corresponding connection database to reflect the new connection to the other node, and/or the hub node may store information associated with the new connection between user nodes.

The term “node content request” refers to electronic generated information by a target/requesting user node transmitted directly, or indirectly via a hub node, to a source user node indicating a desired transfer of node content from the source user node to the target/requesting user node. For example, node content 1 stored on user node 1 may be requested by user node 2 using a node content request sent from user node 2 to user node 1. In some embodiments, a node content request includes a user node associated with the requesting user node. In some embodiments, a node content request includes user node metadata associated with the requesting user node. In some embodiments, a node content request includes a node content identifier for use in identifying the node content being requested.

The term “node content response” refers to electronic information generated by a source user node and transmitted directly, or indirectly via a hub node, to a target user node indicating approval or denial of a node content request. In some embodiments, a node content response is automatically generated by a source user node in response to receiving, on the user node, a node content request. In some embodiments, a node content response includes a node content duplicate. Alternatively or additionally, in some embodiments, a node content response includes a permission set.

The term “permission set” refers to a set of limitations or rules regarding use, edit, or transferability of associated node content. Accordingly, a permission set may include any set of electronically enforced rules for applying limitation(s) on usage, editing, and/or transferring of particular node content. For example, in some embodiments, a permission set includes rules for whether associated node is editable. Additionally or alternatively, in some embodiments, a permission set includes rules for whether associated node content is transferrable to another user node or other user nodes. Additionally or alternatively, in some embodiments, a permission set includes rules for license of the associated node content, transfer of the associated node content, and/or any combination thereof. In some embodiments, a permission set is included as part of a node content response associated with a node content duplicate. In some embodiments, a permission set is associated with newly generated original node content. In some embodiments, a permission set is associated with original node content created by editing existing node content or node content duplicate.

A permission and/or limitation set associated with content transferred from a source node to a requester node. A permission set may any limitation on usage of a node content duplicate. For example, a permission set may include rules for whether a node content duplicate may be edited. Additionally or alternatively, a permission set may include rules for whether a node content duplicate may be further transferred to another user node. Additionally or alternatively, a permission set may include any other rules for license of the node content duplicate, transfer of the node content duplicate, and/or any combination thereof.

The term “node content transfer report” refers to information identifying execution of a node content transfer. In an example embodiment, a node content transfer report includes (1) a source user node identifier (2) a source node content identifier (3) a target user node identifier (4) a target node content identifier and/or (5) a permission set.

The term “node content transfer report ledger” refers to a list, dictionary, or other data storage configured to store a plurality of node content transfer reports. In some embodiments, a node content transfer report ledger is a blockchain ledger such that the node content transfer reports in the ledger may be inspected for information access and/or auditing purposes (e.g., to facilitate attribution of intellectual property rights to the node content transferred in the node content transfer report).

The term “node content edit report” refers to information identifying execution of a node content edit, by a source node, to produce edited node content. In an example embodiment, a node content edit report includes (1) a user node identifier associated with the user node performing the edit, (2) a source node content identifier that uniquely identifies the source node content, and (3) an edited node content identifier that uniquely identifies the edited node content.

The term “node content edit report ledger” refers to a list, dictionary, or other data storage configured to store a plurality of node content transfer reports. In an example embodiment, a node content transfer report ledger is a blockchain ledger such that the node content transfer reports in the ledger may be inspected for information access and/or auditing purposes (e.g., to facilitate attribution of intellectual property rights to the node content transferred in the node content transfer report). In some embodiments, a hub node is configured to manage a node content edit report ledger. In some such embodiments, a hub node is configured to

In some embodiments, a single combined ledger, list, dictionary, or other data storage mean is configured to function both as a node content transfer report ledger and node content edit report ledger. For example, in a particular example embodiment, a single blockchain ledger is configured to operate as both a node content transfer report ledger and a node content edit report ledger.

The terms “manage” used in regard to node content, “managing node content,” and “node content management,” refer to functionality associated with creation, storage, transferring, and/or use of node content. Non-limiting examples of managing node content include, without limitation, creating original node content, editing existing node content, and/or transferring node content between user nodes, and/or storing one or more records associated with such actions.

### System Architecture

Methods, apparatuses, systems, and computer program products in accordance with the present invention are disclosed herein. Said methods, apparatuses, systems, and computer program products may be embodied by any of a variety of devices. For example, the method, apparatus, system, and computer program product of an example embodiment may be embodied by a networked device, configured to communicate with one or more devices, such as one or more user devices, one or more enterprise devices, or one or more other devices. Example embodiments of the user and developer devices include any of a variety of mobile terminals, such as a portable digital assistant (PDA), mobile telephone, smartphone, laptop computer, tablet computer, or any combination of the aforementioned devices. Additionally or alternatively, the method, apparatus, and computer program product of an example embodiment may be embodied by a user device executing one or more software applications and/or modules, such as a software application on a user laptop or smartphone, comprising software modules configured to carry out all or some of the operations disclosed herein, and/or configured to interact with one or more other devices, such as a hub server executing the same or a different software application, software applications, or software modules, and configured to perform all or some of the operations disclosed herein.

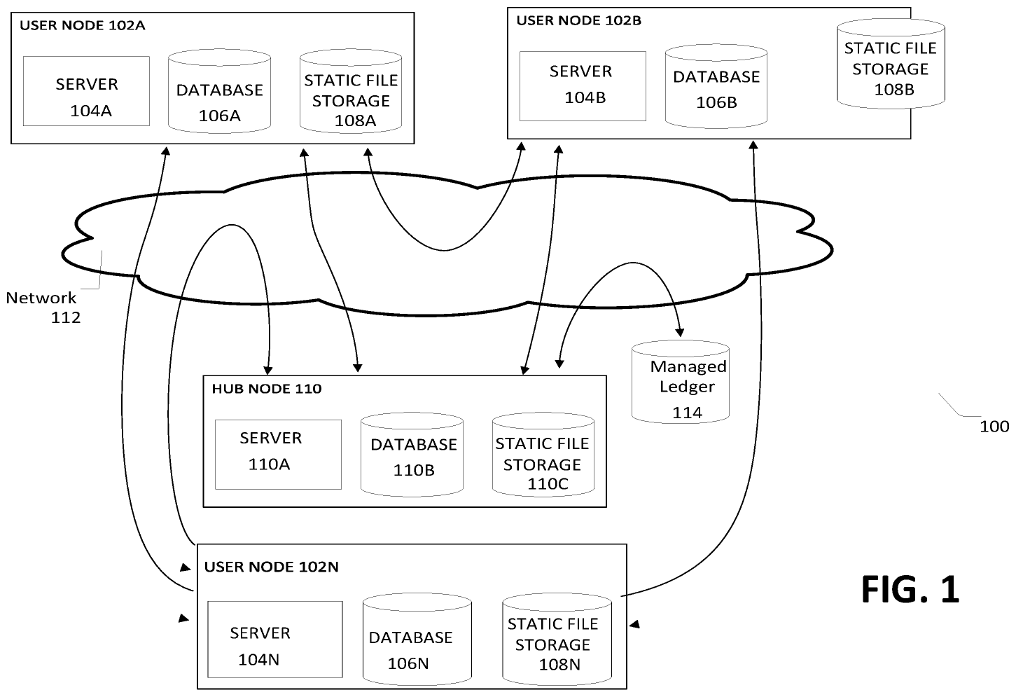

In this regard, FIG. 1 is a block diagram showing an example system 100 within which embodiments of the present invention may operate. For example, an example system includes one or more user nodes, such as user nodes 102A-102N, where N represents any number of user devices, hub node 110, and managed ledger 114.

Each of the illustrated components may be configured to communicate via network 112. In the illustrated system, each of the user nodes 102A-102N may communicate with hub node 110 through the network 112. After a user node registers with the hub node 110, the user node may be configured to communicate with one or more of the other user nodes also registered with the hub node 110. The user nodes 102A-102N may communicate with each other, after registering with the hub node 110, also via network 112, or through a second network (not depicted). By way of example, for simplicity of explanation, three user nodes are depicted in FIG. 1, each configured to communicate the other components through a single network 112.

Each of the user nodes 102A-102N may be a semi-autonomous node instance executed, or “running”, on a user device, such as a laptop, desktop, PDA, tablet, smartphone, or the like. Each of the user nodes 102A-102N may be configured to perform one or more operations for creating, editing, receiving, distributing, and otherwise managing electronic content. For example, each of the user nodes 102A-102N may be configured to create, edit, manage, transfer, and otherwise distribute e-learning content, such as created e-learning activities. E-learning activities may be packaged together to form a course, comprising one or more e-learning activities. Additionally or alternatively, each user node may be configured to store, manage, transfer, or otherwise share other information, such as content licensing business rules, and/or student performance metrics (e.g., student records). Additionally or alternatively still, each user node may be configured to perform one or more services for connecting users or user nodes. For example, a user node may be configured for coordinating real-time communications, such as messaging, video streaming between a course administrator (e.g., a professor or teacher) and one or more students, and the like.

The semi-autonomous nature of each user node allows user nodes to be configured to perform all or some of the above-mentioned operations, or other operations, entirely at the discretion of whomever controls a user node, for example a device owner. In an example embodiment, for example, a user node may be configured to create, edit, and distribute content, but not perform real-time communications. Additionally, user nodes may be configured to operate entirely independently, without networking with peer user nodes. However, the capabilities associated with a user node are greatly enhanced by communicating with other user nodes, such as for the purposes of transferring node content, performing real-time communication, or the like.

Hub node 110 may be configured to connect the one or more user nodes, such as user nodes 102A-102N. For example, hub node 110 may be configured to “register” a user node with the hub, such that other registered user nodes may discover and/or connect to the newly registered user node. In a particular example embodiment, user nodes cannot communicate with other user nodes before registering with the hub node 110. In an example embodiment, hub node 110 is configured to receive a node registration request from a user node (a “registering user node”), register the registering user node, and configure the registering user node to connect to other registered user nodes.

Additionally or alternatively, hub node 110 may be configured to trace content management-related actions performed by a particular user node or performed between two user nodes. For example, hub node 110 may be configured to receive metadata (e.g., a report) that memorializes a content edit, transfer, or the like, and maintain a ledger of all such reports. In an example embodiment, the hub node 110 is configured to store a node content edit report in a ledger, such as managed ledger 114, when a user node, such as one of the user nodes 102A-102N, performs a content edit. The user node performing the edit may be configured to transmit the node content edit report to the hub node 110 as part a protocol, or similar process, for editing content on the corresponding user node. The hub node 110 may also be configured, in some embodiments, to store a node content transfer report in a ledger, such as managed ledger 114, where the node content transfer report includes metadata memorializing a node content transfer from a source user node to a target user node.

Managed ledger 114 may be controlled by, or embodied as a sub-module or sub-sub-system of, hub node 110. In some embodiments, for example hub node 110 controls managed ledger 114 directly, and in some other embodiments, the hub node 110 controls managed ledger 114 via one or more networks. For example, in some embodiments, managed ledger 114 is controlled via one or more APIs. Managed ledger 114 may be a database, ledger, distributed blockchain implementation, or similar implementation. For example, managed ledger 114 may be embodied by a public, hybrid, or private blockchain. In some embodiments, managed ledger 114 configured to store one or more sharing, change log, or other reports associated with content sharing and management. In some embodiments, the managed ledger 114 may only be added to by the hub node 110. For example, managed ledger 114 may be configured to store one or more node content transfer reports and/or one or more node content edit reports, such as those transmitted from the user nodes 102A-102N to hub node 110. In some embodiments, only hub node 110 may add, cause to be added, insert, or otherwise manage adding new reports into managed ledger 114. In some embodiments, a user node group may be able to access the managed ledger 114. The user node group may include all or a portion of the user nodes connected to the network, such as user nodes 102A-102N. Advantageously, the user nodes permitted to access the managed ledger 114 may perform auditing functions or otherwise trace content transfers and edits utilizing managed ledger 114. Furthermore, embodiments in which a user node group may access the user node may perform content attribution by tracing content creation, edits, and/or transfers utilizing the managed ledger 114.

While managed ledger 114 is illustrated as a single component, it should be appreciated that managed ledger 114 may comprise many specialized databases, ledgers, or the like, configured to communicate with one another. In a particular embodiment, managed ledger 114 is implemented as a single blockchain implementation configured to store one or more content management reports, such as node content transfer reports and node content edit reports. In another particular embodiment, managed ledger 114 includes two sub-blockchain implementations, specifically a first blockchain ledger configured to store one or more node content transfer reports and a second blockchain ledger configured to store one or more node content edit reports. As such, the illustrated managed ledger 114 is not to limit the spirit and scope of the disclosure herein.

In the example system illustrated, each of the user nodes 102A-102N includes a server (servers 104A-104N). Each of the servers 104A-104N may be configured, for example based on controlling hardware, software, or a combination thereof, to allow the corresponding user node to communicate via network 112. For example, the server 104A may be configured to allow the user node 102A to communicate with the hub node 110 via network 112. The server 104A may be further configured to, after the user node 102A has registered with the hub node 110, communicate with the other user nodes (e.g., user nodes 102B-102N) via network 112. In some example systems, the servers 104A-104N may be configured to transfer node content to another user node, receive node content from another user node, and/or communicate one or more reports, such as node content transfer reports and node content edit reports, to the hub node 110. In some systems, the servers 104A-104N may also be configured to access the managed ledger 114 for making audit requests, content attribution requests, or the like.

Additionally, in the example system illustrated, each of the user nodes 102A-102N includes a database (databases 106A-106N). Each of the databases 106A-106N may be configured to store node content, communications, and the like, associated with the corresponding user node. For example, database 106A may be configured to store all node content created by, edited by, or transferred to user node 102A. In this regard, each user node 102A-102N may function autonomously with respect to the node content stored by the user node's corresponding database 106A-106N.

Additionally, in the example system illustrated, each of the user nodes 102A-102N includes a static file storage (static file storages 106A-106N). The static file storages 106A-106N may be embodied by a database associated with the corresponding user node. In some systems, static file storages 108A-108N may be sub-databases, or otherwise associated with, database 106A-106N. In other systems, static file storages 108A-108N may be distinct databases, or other permanent storage means, separate from databases 106A-106N. In some systems, each static file is configured to store one or more static files, such as images, documents, or the like. Stored static files, for example images and documents stored in stored file storage 108A, may be included, utilized to create or edit, or otherwise associated with content stored in the corresponding database associated with the user node, for example node content stored in database 106A.

The user nodes may be configured to utilize one or more of the illustrated components to perform the operations described above and further herein. However, it should be appreciated that, in some embodiments, user nodes may be utilize the illustrated components, additional components, alternative components, or a different arrangement of components to perform one or more of the operations described herein. Additionally, while each of the components 104A-108A, 104B-108B, and 104N-108N is illustrated as a single component, it should be appreciated that each of these components may comprise sub-components configured to work in conjunction to perform the operations described herein. Accordingly, the components of each user node, as illustrated, is not to limit the spirit and scope of this disclosure.

Additionally, in the example system illustrated, hub node 110 includes server 110A. The server 110A of the hub node 110 may be configured, for example, utilizing controlling hardware, software, or a combination thereof, to enable the hub node to communicate via network 112. For example, the server 110A may be configured to allow the hub node 110 to communicate with one or more of the user nodes 102A-102N, such as for registration and reporting/tracing purposes. In an example system, the server 110A is configured to allow the hub node 110 to receive one or more registration requests from one or more user nodes 102A-102N. Alternatively or additionally, in an example system, the server 110A is configured to enable the hub node 110 to receive one or more content management reports, such as a node content transfer report and a node content edit report, from one or more user nodes 102A-102N. The server 110A may be further configured to allow the hub node 110 to communicate with, add to, or otherwise maintain managed ledger 114 via network 112.

In a particular example embodiment, hub node 110 cannot communicate with a user node of the user nodes 102A-102N until that user node registers with the hub node 110. For example, upon execution of a new user node instance, due to the semi-autonomous nature associated with each user node, the new user node instance may operate to perform one or more functions entirely independently (e.g., content creation, content editing, and the like) without communicating with the hub node 110 or any other user nodes. In the particular embodiment, the new user node instance may be configured to contact the hub node 110 for registration, however, the hub node 110 remains unaware of the new user node instance until it is contacted, and thus cannot contact the new user node instance until registration occurs.

Additionally, in the example system illustrated, the hub node 110 includes a database 110B. The database 110B may be configured to store node metadata, or other information, associated with registering user nodes, communicating with user nodes, identifying user nodes, and/or connecting registered user nodes. In a particular embodiment, hub node 110 maintains a list or dictionary of node metadata associated with registered user nodes. The node metadata list or dictionary may be stored in database 110B, or an associated storage managed by hub node 110. In some embodiments, database 110B may be a persistent storage or other database implementation.

Additionally, in the example system illustrated, the hub node 110 includes a static file storage 110C. The static file storage 110C may be embodied by a database associated with the hub node 110. In some systems, static file storage 110C may be a sub database, or otherwise associated with, database 110B. In other systems, static file storages 110C may be a database, or other persistent storage means, separate from database 110B.

In some example embodiments, the static file storage 110C of the hub node 110 is configured to store static files utilized by the hub node 110 for one or more operations performed by the hub node 110, for example via the server 110A. In some embodiments, the server 110A may be configured to store received information, such as static files and/or resources utilized by the user node 110, in the static file storage 110C. The information, data, files, or the like, stored in static file storage 110C may be generated by hub node 110 or received from one or more third-party devices, systems, or the like, for example from one or more of the user nodes 102A-102N.

The hub node 110 may be configured to utilize one or more of the illustrated components to perform the operations described above and further herein. However, it should be appreciated that, in some embodiments, a hub node may utilize the illustrated components, additional components, alternative components, or a different arrangement of components to perform one or more of the operations described above or further herein. Additionally, while each component 110A, 110B, and 110C is illustrated as a single component, it should be appreciated that each of these components may comprise sub-components configure to work in conjunction to perform the operations described above or further herein. Accordingly, the components of the hub node 110, as illustrated, is not to limit the spirit and scope of this disclosure.

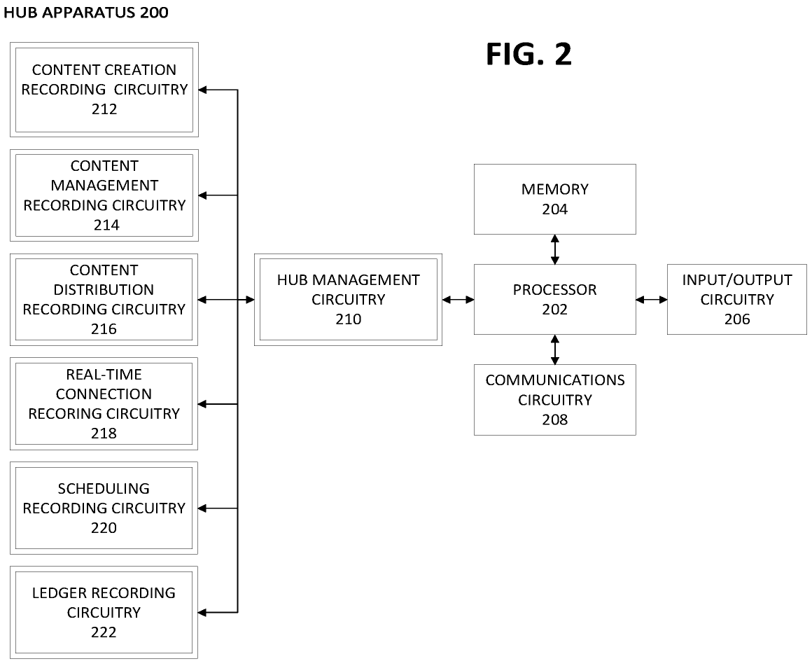

The hub node 110 may be embodied by one or more computing systems, such as hub apparatus 200 shown in FIG. 2. The hub apparatus 200 may include specific hardware modules and/or software modules configured to perform the various operations described herein. As illustrated in FIG. 2, the hub apparatus 200 may include a processor 202, a memory 204, input/output circuitry 206, communications circuitry 208, hub management circuitry 210, content creation recording circuitry 212, content management recording circuitry 214, distribution recording circuitry 216, real-time connection recording circuitry 218, scheduling recording circuitry 220, and ledger recording circuitry 222. The hub apparatus may be configured to execute the operations described above with respect to the hub node 110 in FIG. 1, and below with respect to operations performed by a hub node in the figures below. It should be understood that particular implementations necessarily include the user of particular hardware. It should be understood that certain of the components 202-222 may include similar or common hardware. For example, two components may both leverage use of the same processor, network interface, storage medium, or the like to perform their associated functions, such that duplicate hardware is not required for each component. The use of the terms “module” and “circuitry” as used herein with respect to components of the apparatus therefore includes particular hardware configured to perform the functions associated with the particular component.

Of course, while the terms “module” and “circuitry” should be understood broadly to include hardware, in some embodiments, circuitry may also include software for configuring the hardware. For example, in some embodiments, “module” and/or “circuitry” may include software for configuring processing circuitry, storage media, network interfaces, input/output devices, and the like. In some embodiments, other elements of the apparatus 200 may provide or supplement the functionality one or more circuitry components. For example, the processor 202 may provide processing functionality, the memory 204 may provide storage functionality, the communications module 208 may provide network interface functionality, and the like.

In some embodiments, the processor 202 (and/or co-processor or any other processing circuitry assisting or otherwise associated with the processor) may be in communication with the memory 204 via a bus for passing information among components of the apparatus. The memory 204 may be non-transitory and may include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present invention.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the terms “processing module” and/or “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware or software methods, or by a combination of hardware with software, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the hub apparatus 200 may include input/output circuitry 206 that may, in turn, be in communication with processor 202 to provide output to the user and, in some embodiments, to receive an indication from the user. The input/output module 206 may comprise a user interface and may include a device display, such as a user device display, that may include a web user interface, a mobile application, a client device, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device, module, or circuitry embodied in either hardware or a combination of hardware and software that is configured to receive and/or transmit data from/to a network and/or any other device, circuitry, or module in communication with the apparatus 200. For example, in some embodiments, communications circuitry 208 may facilitate communications between the hub apparatus 200 and one or more user node apparatuses. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the hub apparatus 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX), or other proximity-based communications protocols.

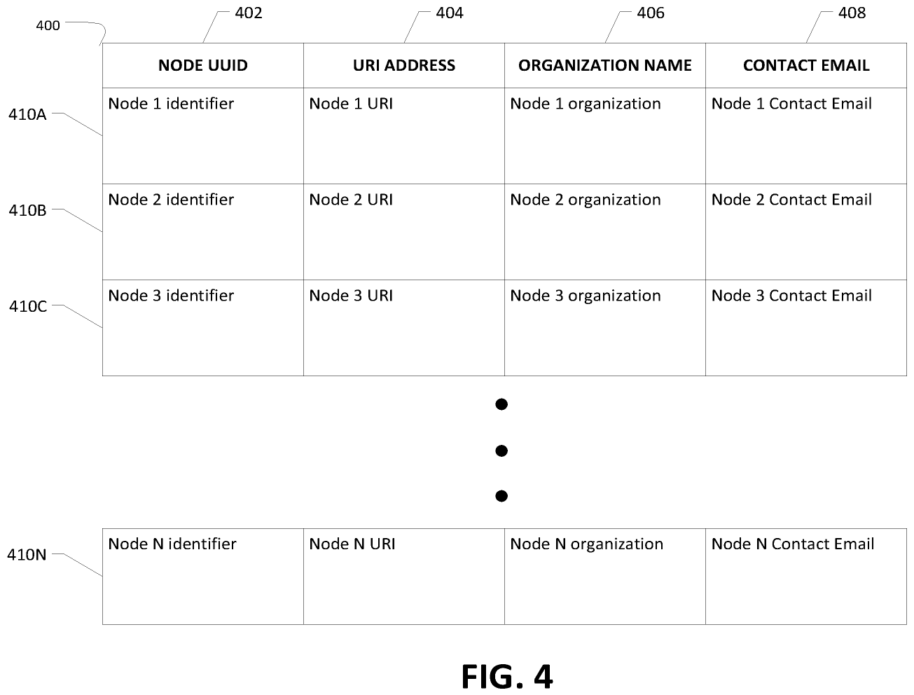

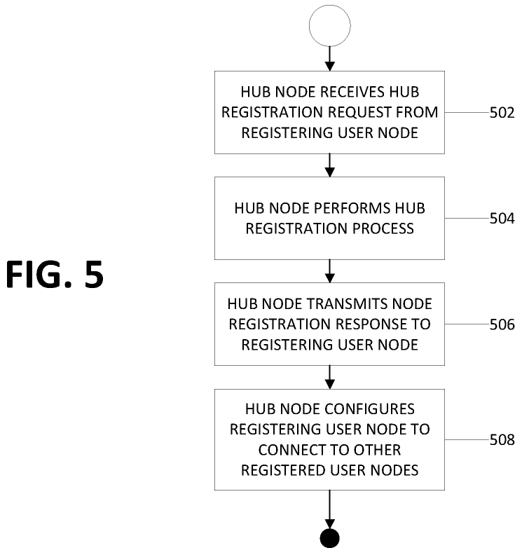

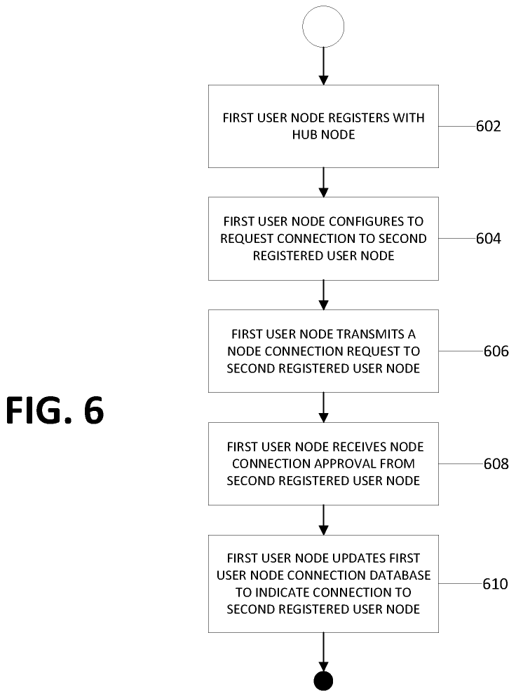

Hub management circuitry 210 may be any means such as a device, module, or circuitry embodied in either hardware or a combination of hardware and software that is configured to manage user node registration, connection, and recording of communications between such user nodes. For example, hub management circuitry 210 may include circuitry, hardware and/or software modules, or the like for maintaining a hub metadata list or dictionary, as described below in regards to FIG. 4, and/or registering and connecting user nodes, as described below in regards to FIGS. 5 and 6. Hub management circuitry 210 may also include circuitry, hardware and/or software modules, or the like for organizing one or more operations in response to communications with a user node, such as communications received by communications circuitry 208. In this regard, hub management circuitry 210 may include one or more data storages, persistent storage devices, and/or buses for communicating with one or more hub operation circuitry components, such as components 212-222 as illustrated, and processor means, such as processor 202 as illustrated. The hub management circuitry may communicate with processor 202 and/or memory 204 to facilitate data flow to each of the components 212-222. Hub management circuitry 210 may utilize a processing module, such as processor 202, and input/output circuitry 206 to receive user indication for processing by one of the circuitry components 212-222. Additionally or alternatively, hub management circuitry 210 may utilize a processing module, such as processor 202, and communications circuitry 208 to receive information and/or data from one or more devices over a network, such as one or more user nodes, for processing by one or more of the circuitry components 212-222. In some embodiments, each of the circuitry components 212-222 may communicate directly with the processor 202, and thus with memory 204, input/output circuitry 206, and communications circuitry 208, to perform their respective operations.

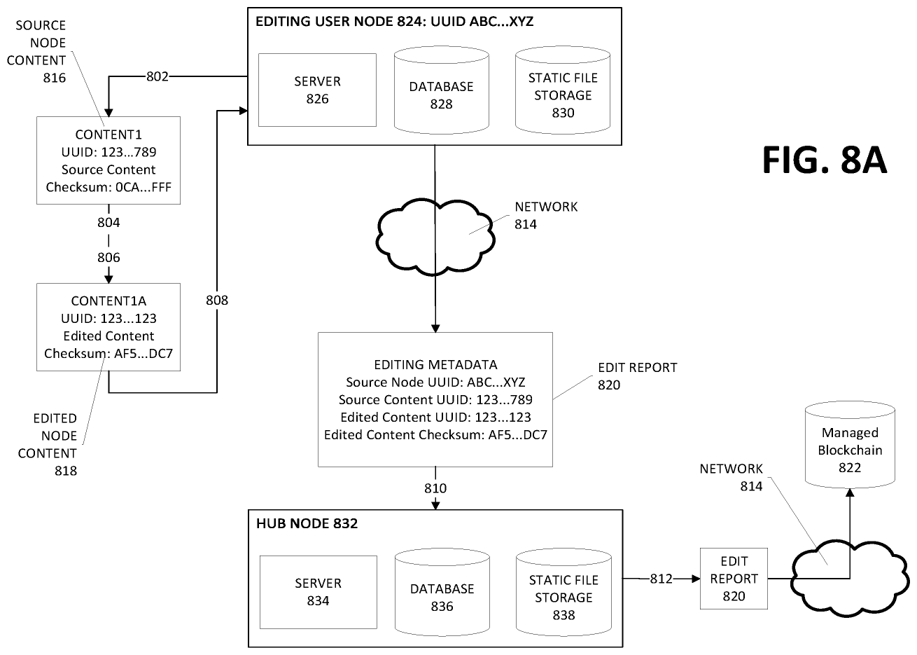

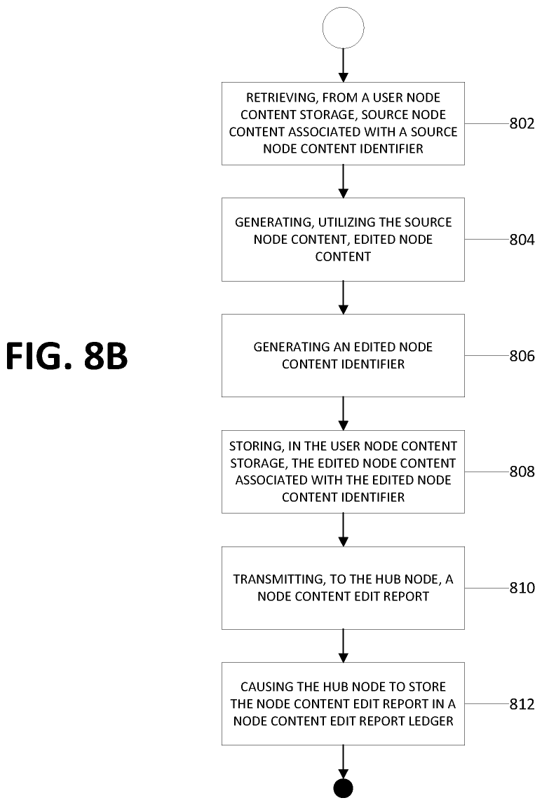

Content creation recording circuitry 212 may be any means such as a device, module, or circuitry embodied in either hardware or a combination of hardware and software that is configured to receive information from one or more user devices associated with generation of original node content by the user node(s), and manage records of node content created by one or more user nodes. Content creation recording circuitry 212 may, for example, utilize a processing module, such as processor 202 and/or hub management circuitry 210, together with memory 204 to receive, maintain, and/or share, with one or more devices, data, information, and/or metadata associated with new and/or edited node content created by a user node. Content creation recording circuitry 212 may utilize additional circuitry, such as ledger recording circuitry 222 and/or communications circuitry 208, to maintain a ledger, such as managed ledger 114 as illustrated in FIG. 1, for enabling content tracing and attribution with regard to original node content. For example, content creation recording circuitry 212 may be configured to perform one or more operations described below with respect to FIGS. 8A and 8B. It should be appreciated that, in some embodiments, the content creation recording circuitry 212 may include a separate processor, specially configured programmable gate array (FPGA), or application specific circuit (ASIC) to perform the described functions.

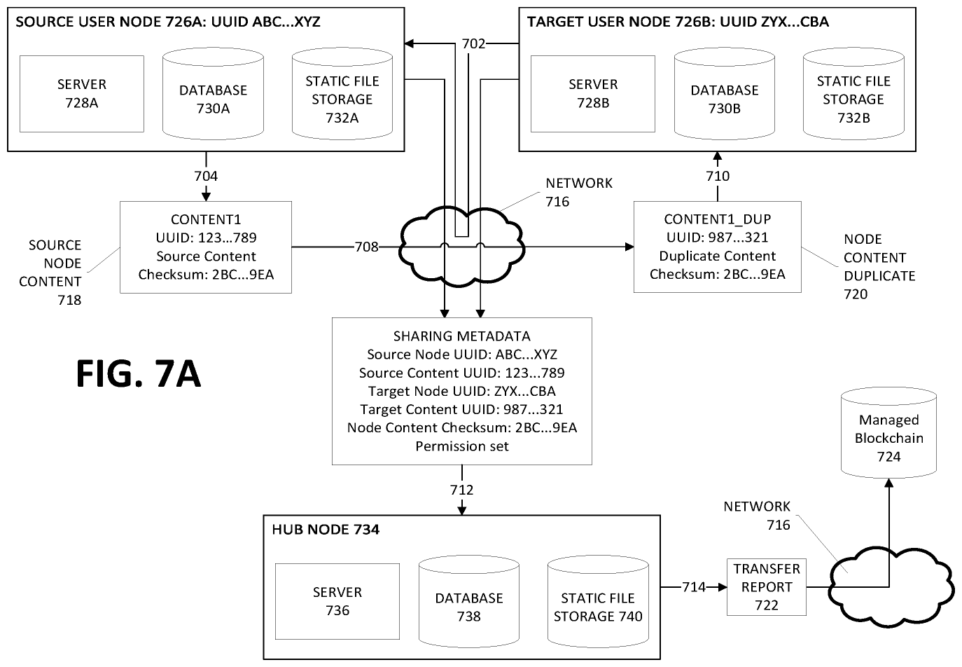

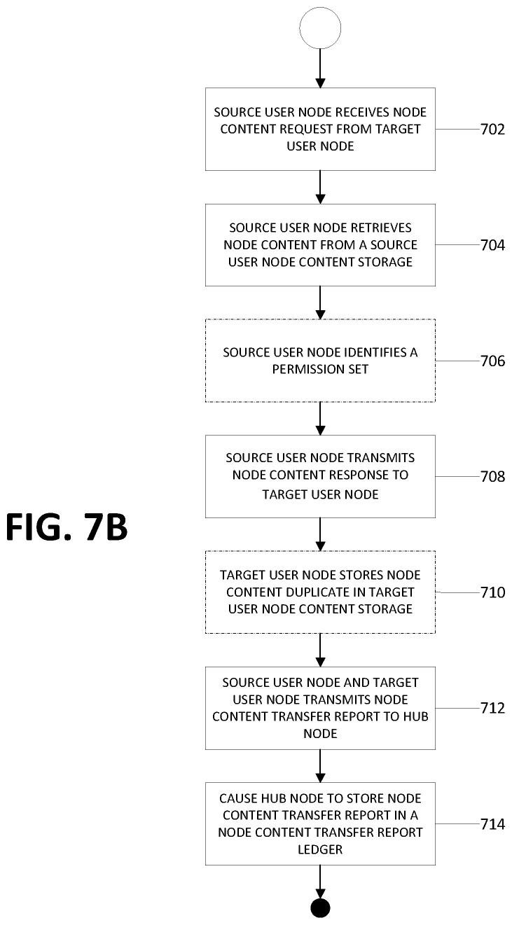

Content management recording circuitry 214 may be any means such as a device, module, or circuitry embodied in either hardware or a combination of hardware and software that is configured to receive information from one or more user nodes associated with node content transfers between user nodes, and manage records of node content transfers between user nodes. Content management recording circuitry 214 may, for example, utilize a processing module, such as processor 202 and/or hub management circuitry 210, together with memory 204 to maintain corresponding metadata, data, information, or the like, associated with a node content transfer between user nodes. In some embodiments, content management recording circuitry includes hardware and/or software means for storing, retrieving, and/or otherwise managing transferred node content. Content management recording circuitry 214 may utilize additional circuitry, such as ledger recording circuitry 222 and communications circuitry 208, to maintain a ledger, such as managed ledger 114 as illustrated in FIG. 1, to enable content tracing and attribution associated with transferred content, such as node content. For example, content management recording circuitry 214 may be configured to perform one or more operations described below with respect to FIGS. 7A and 7B. It should be appreciated that, in some embodiments, the content management recording circuitry 214 may include a separate processor, specially configured programmable gate array (FPGA), or application specific circuit (ASIC) to perform the described functions.

Content distribution recording circuitry 216 may be any means such as a device, module, or circuitry embodied in either hardware or a combination of hardware and software that is configured to manage one or more data, metadata, or information sets associated with content distributions from user nodes configured to function as distributors. Content distribution recording circuitry 216 may, for example, utilize a processing module, such as processor 202 and/or hub management circuitry 210, together with memory 204 to maintain information identifying and/or associated with distributor user nodes. In some embodiments, content distribution recording circuitry 216 includes hardware and/or software configured for receiving, from a user node, metadata, information, or the like that indicates the user node has node content available for transfer by that user node. In this regard, the content distribution recording circuitry 216 may be configured, alone or in conjunction with one or more other modules, to distribute information to a user node upon request, such that the user node may identify distributor user nodes to connect to one or more distributor user node to browse and/or request node content available for transfer. It should be appreciated that, in some embodiments, the content distribution recording circuitry 216 may include a separate processor, specially configured programmable gate array (FPGA), or application specific circuit (ASIC) to perform the described functions.

Real-time connection recording circuitry 218 may be any means, such as a device, module, or circuitry embodied in either hardware or a combination of hardware and software that is configured to manage one or more data, metadata, or information sets associated with real-time communications between user nodes. Real-time connection recording circuitry 218 may utilize a processing module, such as processor 202 and/or hub management circuitry 210, together with memory 204 to generate and/or maintain records associated with real-time communications between user nodes, such as messaging chats, public live video, audio, or chat streams, one-to-many video streams, one-to-one video streams, or the like. It should be appreciated that, in some embodiments, the real-time connection recording circuitry 218 may include a separate processor, specially configured programmable gate array (FPGA), or application specific circuit (ASIC) to perform the described functions.

Scheduling recording circuitry 220 may be any means such as a device, module, or circuitry embodied in either hardware or a combination of hardware and software that is configured to manage one or more data, metadata, or information sets associated with scheduling, calendar management, and the like. Scheduling recording circuitry 220 may, for example, utilize a processing module, such as processor 202 and/or hub management circuitry 210, together with memory 204 to manage and/or track records associated with node content, or corresponding metadata. For example, scheduling recording circuitry 220 may include software and/or hardware for generating and/or maintaining records associated with information received by one or more user nodes regarding course and/or activity deadlines, completion statuses, class meeting and/or video-meeting schedules, and/or the like. It should be appreciated that, in some embodiments, scheduling recording circuitry 220 may include a separate processor, specially configured programmable gate array (FPGA), or application specific circuit (ASIC) to perform the described functions.

Ledger recording circuitry 222 may be any means such as a device, module, or circuitry embodied in either hardware or a combination of hardware and software that is configured to access, maintain, and otherwise manage a data and/or metadata ledger, such as managed ledger 114 as depicted in FIG. 1. Ledger recording circuitry 222 may, for example, utilize a processing module, such as processor 202 and/or hub management circuitry 210, together with memory 204 to store one or more metadata sets, such as node content transfer reports and node content edit reports, in a ledger. For example, ledger recording circuitry 222 may be configured to store data/metadata sets on a public, private, or hybrid blockchain ledger. For example, ledger recording circuitry 222, alone or in conjunction with one or more of the components 212-220, may be configured to perform one or more operations for ledger management described below with respect to FIGS. 7A, 7B, 8A and 8B. It should be appreciated that, in some embodiments, ledger recording circuitry 222 may include a separate processor, specially configured programmable gate array (FPGA), or application specific circuit (ASIC) to perform the described functions.

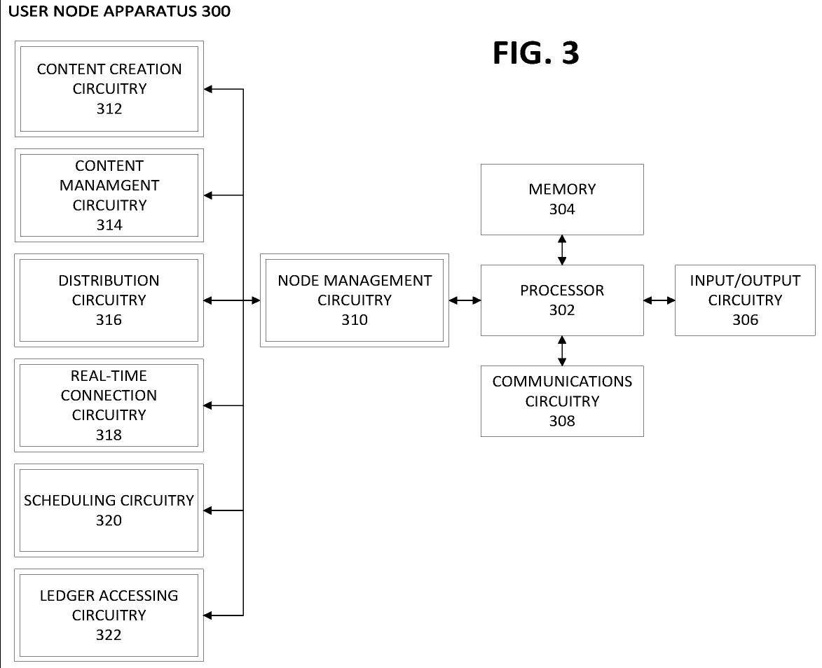

Each of the user nodes 102A-102N may be embodied by one or more computing systems, such as user node apparatus 300 shown in FIG. 3. The user node apparatus 300 may include specific hardware modules and/or software modules configured to perform the various operations described herein. As illustrated in FIG. 3, the user node apparatus 300 may include a processor 302, a memory 304, input/output circuitry 306, communications circuitry 308, node management circuitry 310, content creation circuitry 312, content management circuitry 314, distribution circuitry 316, real-time connection circuitry 318, scheduling circuitry 320, and ledger accessing circuitry 322. The user node apparatus 300 may be configured to execute the operations described above with respect to each of the user nodes 102A-102N in FIG. 1, and below with respect to operations performed by a user node in the figures described below. It should be understood that particular implementations necessarily include the user of particular hardware. It should be understood that certain of the components 302-322 may include similar or common hardware. For example, two components may both leverage use of the same processor, network interface, storage medium, or the like to perform their associated functions, such that duplicate hardware is not required for each component.

The processor 302, memory 304, input/output circuitry 306, and communications circuitry 308 may function similarly, or identically, to the shared name components as described above with respect to FIG. 2, but with respect to the apparatus 300. Thus, for the sake of brevity, additional description of the mechanics of these components is omitted. Nevertheless, these components elements, operating together, provide the respective apparatus 300 with the functionality to facilitate the communication of data, input of data, storage of data, and processing of data/instructions with regard to the operations described herein with respect to the user node apparatus 300.

Node management circuitry 310 may be any means such as a device, module, or circuitry embodied in either hardware or a combination of hardware and software that is configured to manage registration with a hub node and connection to one or more other registered user nodes. For example, node management circuitry 310 may include circuitry, hardware and/or software modules, or the like for communicating requests to/from a hub node. Node management circuitry 310 may include circuitry, hardware and/or software modules, or the like configured for maintaining data, or metadata, associated with one or more user nodes registered to a corresponding hub node. Additionally or alternatively, For example, node management circuitry 310 may include circuitry, hardware and/or software modules, or the like configured for maintaining a data list/dictionary, or metadata list/dictionary, associated with user node with which a connection is currently associated, such as the information necessary to configure the user node apparatus 300 to connect to another registered user node as described below in regards to FIG. 6. User node management circuitry 310 may also include circuitry, hardware and/or software modules, or the like for organizing and/or performing one or more operations in response to communications with another user node, such as in response to node content requests received via communications circuitry 308. In this regard, node management circuitry 310 may include one or more data storages, persistent storage devices, and/or buses for communicating with data storages, persistent storage devices, and/or one or more node operation circuitry components, such as components 312-322 as illustrated, and processor means, such as processor 302 as illustrated. The node management circuitry 310 may communicate with processor 302 and/or memory 304 to facilitate data flow to each of the components 312-322. Node management circuitry 310 may utilize a processing module, such as processor 302, and input/output circuitry 306 to receive user indication for processing by one of the circuitry components 312-322. Additionally or alternatively, node management circuitry 310 may utilize a processing module, such as processor 302, and communications circuitry 308 to receive information and/or data from one or more devices over a network, such as a hub node and/or one or more other user nodes, for processing by one or more of the circuitry components 312-322. In other embodiments, each of the circuitry components 312-322 may communicate directly with the processor 302, and thus with memory 304, input/output circuitry 306, and communications circuitry 308, to perform their respective operations.

Content creation circuitry 312 may be any means such as a device, module, or circuitry embodied in either hardware or a combination of hardware and software that is configured to create new content, such as node content, and/or edit existing content, such as existing node content. Content creation circuitry 312 may, for example, utilize a processing module, such as processor 302 and/or node management circuitry 310, together with memory 304 to generate and store new node content, and/or corresponding metadata, created by a user of the node. Additionally or alternatively, content creation circuitry 312 may, utilizing a processing module, such as processor 302 and/or node management circuitry 310, together with memory 304 to retrieve stored content, such as stored node content, and edit the stored content to create new content. Content creation circuitry 312 may also, for example, be configured to maintain and/or communicate with one or more databases and/or persistent storages for storing newly created and/or edited node content. Content creation circuitry 312 may utilize additional circuitry, such as communications circuitry 308, to transmit one or more data sets and/or metadata sets, such as node content edit reports, to a hub node for addition to a ledger, such as managed ledger 114 as illustrated in FIG. 1, to enable content tracing and attribution. For example, content creation circuitry 312 may be configured to perform one or more operations for editing node content described below with respect to FIGS. 8A and 8B. Content creation circuitry 312 may include one or more tools configured for creating original node content from scratch and/or creating original node content for addition to existing node content. For example, content creation circuitry 312 may include software, hardware, or a combination thereof, for document management, image generation and/or manipulation, and/or word processing. It should be appreciated that, in some embodiments, the content creation circuitry 312 may include a separate processor, specially configured programmable gate array (FPGA), or application specific circuit (ASIC) to perform the described functions.

Content management circuitry 314 may be any means such as a device, module, or circuitry embodied in either hardware or a combination of hardware and software that is configured to transfer node content to at least one other user node substantively connected to the apparatus 300, and/or receive transferred node content from at least one other connected user node. Additionally, content management circuitry 314 may include means configured to store, or otherwise manage, transferred content in a database or persistent storage. Content management circuitry 314 may also include means, such as a device, module, or circuitry embodied in either hardware or a combination of hardware and software that are configured to transfer metadata or other information associated with transferred node content. For example, content management circuitry 314 may utilize a processing module, such as processor 302 and/or node management circuitry 310, together with memory 304 to transmit one or more node content transfer reports, or metadata corresponding to portions of one or more node content transfer reports, to a hub node for storage in a transfer ledger, such as managed ledger 114 as illustrated in FIG. 1, to enable content tracing and attribution associated with transferred content. For example, content management circuitry 314 may be configured to perform one or more operations described below with respect to FIGS. 7A and 7B. In some embodiments, content management circuitry 314 may include software and/or hardware for requesting connection to another user node, viewing substantively connected user nodes, and/or selecting substantively connected user nodes to transfer content to or receive content from. It should be appreciated that, in some embodiments, the content management circuitry 314 may include a separate processor, specially configured programmable gate array (FPGA), or application specific circuit (ASIC) to perform the described functions.

Distribution circuitry 316 may be any means such as a device, module, or circuitry embodied in either hardware or a combination of hardware and software that is configured to enable and perform distribution of content, such as node content, to one or more other user nodes. User nodes including distribution circuitry 316 may be referred to as “distributor nodes” or “distributor user nodes.” Distribution circuitry 316 may, for example, utilize a processing module, such as processor 302 and/or node management circuitry 310, together with memory 304 to mark content, such as node content, for distribution and maintain information identifying and/or associated with content marked for distribution. It should be noted that some user node apparatuses in a system may include distribution circuitry 316, while others may not. In some embodiments, the distribution circuitry 316 includes hardware and/or software enabling a user to select stored node content for distribution, and/or viewing node content available for distribution via one or more substantively connected user nodes. It should be appreciated that, in some embodiments, the distribution circuitry 316 may include a separate processor, specially configured programmable gate array (FPGA), or application specific circuit (ASIC) to perform the described functions.

Real-time connection circuitry 318 may be any means, such as a device, module, or circuitry embodied in either hardware or a combination of hardware and software that is configured to enable and perform real-time communications with another user node. For example, real-time connection circuitry 318 may utilize a processing module, such as processor 302 and/or node management circuitry 310, together with memory 304 to transmit/receive real-time messages to/from another user node, transmit/receive video streaming information to/from another user node, or otherwise perform real-time communication with another user node. Additionally or alternatively, real-time connection circuitry 318 may utilize a processing module, such as processor 302 and/or node management circuitry 310, together with memory 304 to maintain information and/or metadata associated with real-time communications transmitted to/received from another user node, such as chat messages, livestream information, one-to-many video streams, one-to-one video streams, or the like. Real-time connection circuitry 318 may also utilize additional components, such as communications circuitry 308, to transmit real-time communications to/receive real-time communications from another user node, and/or transmit one or more data, metadata, or instruction sets associated with real-time communications to a hub node.

The real-time connection circuitry 318 may include software, hardware, or a combination thereof, embodying one or more tools for establishing real-time connections with one or more substantively connected user nodes, and transmitting real-time communications via such connections. It should be appreciated that, in some embodiments, real-time connection circuitry 318 may include a separate processor, specially configured programmable gate array (FPGA), or application specific circuit (ASIC) to perform the described functions.

Scheduling circuitry 320 may be any means such as a device, module, or circuitry embodied in either hardware or a combination of hardware and software that is configured to enable scheduling, calendar management, and/or meetings for users of a particular user node or between users associated with a plurality of user nodes. In some embodiments, scheduling circuitry 320 is configured via hardware and/or software to generate events, deadlines, meetings, calendar appointments, and/or the like associated with one or more courses, activities, events, webinars, classes, or other offerings provided by the user node embodied by user node apparatus 300. Scheduling circuitry 320 may, in some embodiments, generate and/or otherwise facilitate scheduling of such data objects based on a one-to-one, one-to-many, or many-to-many relationship between node content and associated users.

For example, in some embodiments, user node apparatus 300 may be associated with one or more courses having one or more enrolled students. In a particular example, a course may be associated with one or more activities for completion by enrolled students, such as homework and/or tests, and one or more planned classes, meetings, webinars, or the like. The scheduling circuitry 320 may enable an administrator associated with the course, for example an assigned instructor or other course administrator, to designate dates associated with each activity, sequence of activities, class, meeting, webinar, and/or the like, and create corresponding meetings notifications, alerts, calendar events, or other scheduling data objects.

The scheduling circuitry 320 may further be configured to include, or be associate with, a student management module to track student progress on activities, activity success metrics, activity completion rate metrics, overall course progression, and the like, for example by utilizing activity completion data. In some embodiments, the student management module embodied by or associated with scheduling circuitry 320, alone or in conjunction with other circuitry and/or modules, is configured to notify the student of upcoming deadlines within a certain threshold timestamp interval from a current timestamp. Alternatively or additionally, in some example embodiments, scheduling circuitry 320 is configured to utilize activity completion data to generate one or more alert messages, meeting invitations, calendar events, or the like. The scheduling circuitry 320 may enable an administrator of a course to create and/or edit one or more business rule sets for generating and/or transmitting such data. For example, in some embodiments, scheduling circuitry 320 may generate and/or transmit an alert message to one or more students in response to determining, such as based on activity completion data, that the one or more students did not complete an assignment or did not complete a threshold count of assignments. Additionally or alternatively, scheduling circuitry 320 may generate and/or transmit one or more scheduling events, meetings, calendar events, or the like to the instructor and the students determined not to complete the assignment(s) for a meeting.

In some embodiments, the scheduling circuitry 320 may be configured to access one or more calendars or other event tracking logs associated with an instructor and one or more students. For example, the scheduling circuitry 320 may be configured, alone or in combination with one or more other circuitry components and/or modules, to communicate with one or more external systems, devices, or the like for accessing scheduling data associated with a student and/or instructor. In this regard, the scheduling circuitry 320 may utilize one or more APIs and hardware means for retrieving scheduled calendar events associated with students and/or instructors via one or more third-party accounts and/or services.

In some embodiments, the student management module and/or scheduling circuitry 320 may be configured to utilize activity completion data associated with one or more students to learn activity completion trends and/or otherwise predict when a student is unlikely to complete an upcoming activity. In this regard, the scheduling circuitry 320 may embody and/or utilize a machine learning and/or algorithmic model configured for generating a completion prediction indicator associated with whether a student is predicted to complete an activity by an associated deadline. The machine learning model may utilize unsupervised or supervised learning implementations associated with any of a myriad of machine learning types to produce various classifications (e.g., is a student user likely falling behind? Is a student user high performing?), predictions (e.g., how likely is a student user to fall behind? How likely is it a student user will miss one or more assignments?), or other data analysis scores or values. For example, in some embodiments, a machine learning model is configured to generate the completion prediction indicator that represents a probability that the student completes the associated activity in time. In other example embodiments, a machine learning model is configured to predict a binary classification indicator that indicates the student is predicted, or not predicted to, complete the activity by the associated deadline. The machine learning model may be trained to generate the completion prediction indicator based on activity completion data and/or other student data associated with students associated with a particular course, activity, or the like. For example, in some embodiments, one or more machine learning models may be trained based on activity completion data for the student or for all students enrolled in a course (e.g., have almost all students completed a particular activity or is a particular student falling behind, data regarding how a particular student scored on a particular activity in comparison to the remainder of the students that completed the activity). In some embodiments, course data used to train one or more predictive models may be parsed based on actions by various student users associated with a particular course data object, various iterations of a course data object (e.g., data associated with the completion of student users from a first class, data associated with the completion of activities by student users from a second class, and the like), or various subgroups of student users (e.g., student users determined to be highly achieving in a first group, and student users determined to be falling behind in a second group).

Based on the prediction(s) generated associated with a particular student, for example by a student management module, the scheduling circuitry 320 may be configured to generate scheduling events (e.g., calendar deadlines) for each perceived student's learning rate. For example, the scheduling circuitry 320 may be able to detect a student is falling behind and/or generally slower at learning current material, and generate or change one or more scheduling events associated with one or more activities (e.g., set and/or change one or more upcoming activity deadlines). The scheduling circuitry 320 may be configured to adjust the difficulty of a course, alone or in conjunction with one or more components, circuitry, and/or modules, for students determined to be successfully progressing through a course ahead at or more quickly a threshold rate.

Additionally or alternatively, in some example embodiments, the scheduling circuitry 320 is configured to proactively generate one or more alerts messages, scheduling events, or the like, associated with a student and/or the instructor associated with an activity or course. For example, where a student is determined to be falling behind and/or performing below a particular performance threshold, the scheduling circuitry 320 may generate an alert message indicating the student is falling behind, and transmit the alert message to the student and/or an instructor associated with an activity or course. Additionally or alternatively, the scheduling circuitry 320 may generate a meeting event to be attended by both the instructor and the student. The scheduling circuitry 320 may determine a timestamp interval associated with the meeting event based on the scheduled calendar events for the student and instructor, such that the meeting event occurs during a timestamp interval during which both the student and instructor have no currently scheduled calendar events.

Similarly, the scheduling circuitry 320 and/or student management module may provide reporting information regarding current progress associated with a course data object, an activity data object, or the like, or reporting regarding predicted progress. In an example context, reports may be generated based on completed activities, missed activities, activity completion rate for the student, and/or the like. The scheduling circuitry 320 or student management module may generate reports and present the generated reports to an administrator user associated with a course data object and/or a student user for analysis. A report based on the predictions for the student user may indicate that the actions of a student user is likely to result in falling behind, or otherwise associated with falling behind, based on activity completion metrics, score data, and the like collected for all student users or a particular set of student users associated with a course data object.

Scheduling circuitry 320 may, for example, utilize a processing module, such as processor 302 and/or node management circuitry 310, together with memory 304 to generate calendar invites associated with node content stored by user node apparatus 300, transmit/receive calendar invites or other scheduling means associated with node content stored by user node apparatus 300, or perform similar operations with regards to other user node providing content accessed by the user node embodied by user node apparatus 300. In some embodiments, the scheduling circuitry 320 embodies or includes one or more tools for generating scheduled events associated with an activity and/or course, for example a data object representing a due date for an activity or a calendar meeting associated with a video or in-person meeting. It should be appreciated that, in some embodiments, scheduling circuitry 320 may include a separate processor, specially configured programmable gate array (FPGA), or application specific circuit (ASIC) to perform the described functions.

Ledger accessing circuitry 322 may be any means such as a device, module, or circuitry embodied in either hardware or a combination of hardware and software that is configured to access, read from, or otherwise view a data and/or metadata ledger, such as managed ledger 114 as depicted in FIG. 1. Ledger accessing circuitry 322 may, for example, utilize a processing module, such as processor 302 and/or node management circuitry 310, together with memory 304 to view one or more metadata sets, such as node content transfer reports or node content edit reports, stored in a ledger. For example, ledger accessing circuitry 322 may be configured to read one or more content reports stored on a public, private, or hybrid blockchain ledger. Accordingly, ledger accessing circuitry 322 may include means configured to perform auditing and/or tracing of node content utilizing the one or more content reports stored on the ledger, such as a blockchain ledger, for example by being configured to trace node content to an original creator to ensure proper attribution. In some embodiments of the apparatus 300, ledger accessing circuitry 322, together with processor 302 and/or node management circuitry 310, memory 304, communications circuitry 308, and one or more of the operations circuitry 312-320, may be configured to generate and transmit a content report, such as a node content transfer report and node content edit report, or a portion thereof, as part of an operation described below with respect to FIGS. 7A, 7B, 8A and 8B. In some embodiments, ledger accessing circuitry 322 is configured to transmit, to a hub node, metadata associated with one or more actions performed in conjunction with one or more of the other components described above, such that the hub node may utilize the metadata to generate and/or store a report, such as a node content transfer report, node content edit report, or other content report. It should be appreciated that, in some embodiments, ledger accessing circuitry 322 may include a separate processor, specially configured programmable gate array (FPGA), or application specific circuit (ASIC) to perform the described functions.

As will be appreciated, any such computer program instructions and/or other type of code may be loaded onto a computer, processor, or other programmable apparatus' circuitry to produce a machine, such that the computer, processor, or other programmable circuitry that executes the code on the machine creates the means for implementing various functions, including those described herein.

As described above and as will be appreciated based on this disclosure, embodiments of the present invention may be configured as systems, methods, mobile devices executing software applications, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having described specific components of example devices involved in the present disclosure, example data flows, and corresponding systems in which example embodiments of the present disclosure may operate, are described below with respect to the remaining figures.

### Example Hub Metadata Management

FIG. 4 illustrates an example registered user node list including a node metadata list/dictionary, specifically node metadata dictionary 400. Hub apparatus 200 may include means, such as processor 202, hub management circuitry 210, and/or the like, configured to generate and/or maintain node metadata dictionary 400 for all nodes registered with the hub node embodied by hub apparatus 200.

Node metadata dictionary 400 includes node metadata header set including node metadata headers 402-408, specifically NODE UUID header 402, URI ADDRESS header 404, ORGANIZATION NAME 406, and CONTACT EMAIL 408. Hub node apparatus 200 may include means, such as processor 202, hub management circuitry 210, communications circuitry 208, and/or the like, for receiving a user node metadata set from a user node upon registering with the hub node by the user node. The received user node metadata set may include each of the node metadata headers 402-408. Additionally, the illustrated node metadata dictionary 400 includes node metadata records 410A-410N, where N is any number of node metadata records.

NODE UUID header 402 may refer to a user node identifier that uniquely identifies a user node registered with the hub node. URI ADDRESS header 404 may refer to a uniform resource identifier (URI) for contacting the associated user node. For example, URI ADDRESS header 404 may refer to a hostname or IP address associated with the user node including the UUID listed under the NODE UUID header 402. ORGANIZATION NAME header 406 may refer to a first name and/or last name of a user managing the associated user node, or an entity name of an entity managing the associated user node. For example, some user nodes may be managed by individuals, other user nodes may be managed by a company, school, or other entity. CONTACT EMAIL header 408 refers to any electronic mailing address or server associated with the corresponding user node.

In other node metadata lists/dictionaries, a corresponding node metadata header set may include additional, partially different, entirely different, or an alternative arrangement of node metadata headers. Accordingly, a variety of node metadata lists/dictionaries may be constructed, such that each node metadata record (e.g., each of the node metadata records 410A-410N) uniquely identifies a single user node, such as a user node embodied by a user node apparatus 300.

Hub apparatus 200 may include means, such as processor 202, hub management circuitry 210, and/or the like, for generating a node metadata list/dictionary, such as the node metadata dictionary 400, for example upon initialization and/or execution. A generated node metadata list/dictionary may, for example, be generated without any associated node metadata records.

Hub apparatus 200 may also include means, such as processor 202, hub management circuitry 210, communications circuitry 208, and/or the like, for receiving a hub registration request from a user node, for example via a network. An example hub registration request may include indicate the user node would like to register with the hub node, such a hub node embodied by a hub apparatus 200. The received hub registration request may include a user node metadata set, which may include the metadata associated with one or more user node metadata headers associated with the generated node metadata list/dictionary. Upon receiving a hub registration request, the hub apparatus 200 may include means, such as processor 202, hub management circuitry 210, and/or the like, for performing a hub registration process. In an example hub registration process, the hub apparatus 200 may include means configured to verify a user node identifier, or other received key that is to uniquely identify a user node, is in fact unique. Continuing the example hub registration process, the hub apparatus 200 may also include means configured to then insert some or all of the user node metadata in the user node metadata set as a new node metadata record.

In the illustrated example node metadata dictionary 400, a number of user nodes have registered, specifically nodes 410A-410N, where N represents the total number of nodes registered. Each of the user nodes 410A-410N may have transmitted a hub registration request, and were subsequently registered according to a hub registration process. For example, node metadata record 410A refers to a user node associated with the user node identifier “Node 1 Identifier”. The user node associated with node metadata record 410A is associated with a URI address “Node 1 URI,” and operated by an organization named “Node 1 organization” that can be contacted via contact email “Node 1 Contact Email”. In the illustrated example node metadata dictionary 400, only the NODE UUID header 402 is required to uniquely identify a corresponding user node associated with a particular node metadata record.

After registering with the hub node, such as hub apparatus 200, all user nodes corresponding to a user node metadata record in the node metadata list/dictionary, such as node metadata dictionary 400, may be configured to connect with one another to perform real-time communications, transfer content, and the like, as described further herein.

### Example System Data Flow

FIG. 5 illustrates a flow chart that contains operations in which embodiments of the present disclosure may operate, specifically a flow chart illustrating an example process for registering a user node (e.g., a registering user node) to a hub node. Operations in FIG. 5 may be performed by a hub node, such as a hub node embodied by the hub apparatus 200, in communication with a user node, such as a user node embodied by a user node apparatus 300, via a network.

In some embodiments, user nodes are created and provisioned for use via a registration process. The registration process may authorize an operation that results in the creation of the user node. For example, in some embodiments, the registration process is provided entirely through one or more centralized servers communicable by a user device for the purposes of creating the user node via the user device. It should be appreciated that in some embodiments, the registration process may be facilitated by a server associated with the hub node. In other embodiments, the registration process may be facilitated by any number of servers controlled by various third-parties.

Upon completion of the registration process, a user node is created that is embodied by, or executed via, a user device. In some embodiments, the user node is fully autonomous with respect to generation, storage, and editing of node content controlled via the user node. For example, the newly created user node may be provisioned with various default functionality enabled by one or more models associated with the user node. Alternatively, the user node may be provisioned by default to perform various functionality selected by a user.

The newly created user node may be provisioned to be able to communicate with a hub node to register for the purpose of communicating with other user nodes and sharing node content between the various user nodes. In some such embodiments, the user node may be considered semi-autonomous with respect to the functionality facilitated by registering with the hub node. The user node may communicate with the hub node via one or more networks, and subsequently communicate directly or indirectly (i.e., via the hub node) with one or more peer user nodes via one or more networks.

At block 502, the hub apparatus 200 embodying the hub node may include means, such as processor 202, communications circuitry 208, and/or the like, for receiving a hub registration request from a registering user node. A hub registration request may be transmitted to the hub apparatus 200 from a user node apparatus 300 over a network. The hub registration request may include a user node metadata set. For example, the hub registration request received by the hub apparatus 200 may include a user node identifier that uniquely identifies the registering user node.

At block 504, the hub apparatus 200 embodying the hub node may include means, such as processor 202, hub management circuitry 210, and/or the like, for performing a hub registration process. In an example node registration process, the hub apparatus 200 embodying the hub node may include means configured to insert and store some or all of the received user node metadata in a registered user node list/dictionary, such as a registered node metadata dictionary 400. Additionally, in another example node registration process, the hub apparatus 200 embodying the hub node may include means configured to verify some or all of the received registering node metadata. For example, the hub apparatus 200 may verify that a received user node identifier is not already included in the registered node metadata list/dictionary before inserting the received user node metadata in the registered node metadata list/dictionary.

At block 506, the hub apparatus 200 embodying the hub node may include means, such as processor 202, hub management circuitry 210, communications circuitry 208, and/or the like, for transmitting a node registration response to the registering user node. The node registration response may include data and/or information, such as a registration status, that indicates whether the hub node successfully completed the registration process for the registering user node. In an example system, the hub apparatus 200 embodying the hub node may also include means, such as processor 202, hub management circuitry 210, and/or the like, for generating the node registration response.

At block 508, the hub node configures the registering user node to connect to other registered user nodes in the registered user node list. In an example system, the node registration response transmitted at block 506 may include a portion of the user node metadata stored by the hub node in a registered node metadata list/dictionary, such as a user node identifier and URI address. The hub node may cause the registering user node to be configured to other registered user nodes to store the received user node metadata, enabling the registering user node to utilize this information for connecting communicating with the one or more other user nodes associated with the user node metadata.

FIG. 6 illustrates a flow chart that contains operations in which embodiments of the present disclosure may operate, specifically a flow chart illustrating an example node connection process for enabling two user nodes to transfer content, such as node content, and the like. Operations in FIG. 6 may be performed by a user node, such as a user node embodied by a user node apparatus 300, in communication with a hub node, such as a hub node embodied by the hub apparatus 200, via a network.

At block 602, the user node apparatus 300 embodying the first user node includes means, such as processor 302, node management circuitry 310, communications circuitry 308, and/or the like, for registering with a hub node. For example, the first user node may register with the hub node by transmitting a hub registration request to the hub node, and undergoing a hub registration process via the hub node. In a particular example, the user node apparatus 200 embodying the first user node includes means for registering with the hub node in accordance with the operations illustrated in FIG. 5 and described above.

At block 604, the user node apparatus 300 embodying the first user node includes means, such as processor 302, node management circuitry 310, and/or the like for configuring the first user node to request connection to a second registered user node. The second registered user node may be embodied by a second user node apparatus 300. The second registered user node may have registered with the hub node, such as via the process illustrated in FIG. 5, before the first user node reaches block 604 in the process illustrated in FIG. 6.

Accordingly, after block 604, the first user node and the second registered user node are not substantively connected such that they may transfer node content, scheduling content, or real-time communications (e.g., chat messages, livestreaming, and/or the like). However, the first user node and the second registered user node are configured such that they may request a substantive connection. In a particular example, a first user node and a second registered user node may establish such a substantive connection via the operations 606-610.

At block 606, the user node apparatus 300 embodying the first user node includes means, such as processor 302, user node apparatus 310, communications circuitry 308, and/or the like, for transmitting a node connection request to the second registered user node. In a particular example, the node connection request may include at least a user node identifier associated with the first user node. For example, a node connection request may include a user node metadata set, which may include a user node identifier that uniquely identifies the first user node.

In some embodiments, the node connection request is transmitted from the first user node to the second registered user node through a hub node. For example, the first user node may transmit the node connection request to the hub node, where the node connection request identifies the second registered user node to connect to. The hub may identify the second registered user node by parsing the node connection request and using information identifying the second registered user node. The hub node may relay the received node connection request to the registered second user node by forwarding it to the second registered user node. In other embodiments, based on information received by the hub node during and/or after a registration process, the first user node may transmit the node connection request directly with the second registered user node.

The user node apparatus 300 embodying the second registered user node may include means, such as processor 302, communications circuitry 308, node management circuitry 310, and/or the like, for receiving, generating a response to, and responding to, the node connection request. For example, once the second registered user node receives the node connection request, the second user node may make an approval determination indicative of whether the node connection request will be approved or rejected. Accordingly, the second registered user node may subsequently generate a node connection approval (e.g., if the node connection request was determined approved) or a node connection rejection (e.g., if the node connection request was determined rejected). In an example process, the generated response is then transmitted to the first user node. Assuming the node connection request is approved by the second registered user node, the illustrated flow chart continues to block 608.

At block 608, the user node apparatus 300 embodying the first user node may include means, such as processor 302, communications circuitry 308, node management circuitry 310, and/or the like, for receiving a node connection approval from the second registered user node. The node connection approval may include a second user node identifier associated with the second registered user node. For example, a particular example node connection approval may include a second user node metadata set associated with the second registered user node, where the second user node metadata set includes the second user node identifier that uniquely identifies the second registered user node. Additionally, a node connection approval may include an approval indicator used to indicate whether the second registered user node approved the node connection request, which may be a flag, numeric or alphanumeric string, single-bit identifier, or other machine-readable identifier.

In some embodiments, the node connection approval is transmitted from the registered second user node to the first user node indirectly via the hub node. For example, the second registered user node may transmit the node connection approval to the hub node in response to receiving a node connection request relayed through the hub node. The hub node may relay the received node connection approval (or node connection rejection) to the first user node by forwarding it to first user node. In other embodiments, based on information received by the hub node during and/or after a registration process, or based on information received in the node connection request, the first user node may receive the node connection approval directly from the second registered user node.

In some such embodiments, the hub node is configured to generate and/or maintain a node connection report. The node connection report may summarize information associated with the first user node, the second user node, and/or the connection thereof. For example, the node content report may include at least node metadata associated with the first user node and/or the second user node, a connection identifier uniquely identifying the connection between the first user node and the second user node, and/or information for enabling the connection between the first user node and the second user node (e.g., key and/or encryption information). In some embodiments, the node connection report may be generated based on the node connection request, the node connection response, and/or the combination thereof. The hub node may store the node connection report in a ledger and/or database, for example a blockchain ledger, traditional database, or the like. The stored node connection report may be retrieved to enable actions between the first user node and the second user node.

At block 610, the user node apparatus 300 embodying the first user node may include means, such as processor 302, node management circuitry 310, and/or the like, for updating a first user node connection database to indicate a connection to the second registered user node. The first user node database may, for example, be configured to store, retrieve, and/or otherwise manage information associated with other registered user nodes which have been substantively connected to the first user node, such as by requesting connection via a node connection request and receiving node connection approval. For example, at block 610, the first user node may be configured to add one or more received second user node metadata portions to the first user node connection database, such as the second user node identifier that uniquely identifies the second registered user node, an authentication/security token that may be used to verify approval by the second registered user node, and/or the like. The first user node embodied by the user node apparatus 300 may include means, such as processor 302, node management circuitry 310, and/or the like for extracting the second registered user node metadata portions to be stored in the first user node connection database from the node connection approval received at block 608.

Additionally, the user node apparatus 300 embodying the second registered user node may include means, such as processor 302, node management circuitry 310, and/or the like, for updating a second user node connection database (e.g., a user node connection database associated with the second registered user node) to indicate a connection to the first user node. The second user node database may, for example, be configured to store, retrieve, and/or otherwise manage information associated with other registered user nodes which have been substantively connected to the second registered user node, such as by requesting connection via a node connection request and node connection approval. For example, the second registered user node may be configured to add one or more received first node metadata portions to the second user node connection database. For example, the added first node metadata portions may include the first user node identifier that uniquely identifies the first user node, an authentication/security token that may be used to verify the request sender is the first user node, and/or the like. The second registered user node embodied by the user node apparatus 300 may include means, such as processor 302, node management circuitry 310, and/or the like, for extracting first user node metadata portions to be stored in the second registered user node connection database from the node connection request transmitted at block 606.

Upon completing a node connection process, such as the operations illustrated in FIG. 6, a first user node is substantively connected to a second user node, and both the first user node and second user node are registered with a hub node. Accordingly, the substantively connected user nodes may make content requests to receive content requests from other user nodes to which they are substantively connected. These operations may include, but are not limited to: transferring node content, receiving transferred node content, transmitting/receiving scheduling and/or calendar content, real-time streaming of node content (e.g., node-to-node or node-to-many-node livestreaming or communication of audio, video, and/or text communications), and/or the like.

FIG. 7A is a block diagram showing an example system and data flow for transferring content, such as node content, from a source user node (user node 726A) to a target user node (user node 726B) with attribution and tracing enabled via a hub node (hub node 734), within which embodiments of the present invention may operate.

Source user node 726A, target user node 726B, and hub node 734 are configured to communicate with one another via network 716. Additionally, hub node 734 is also configured to communicate with managed blockchain 724 via network 716. However, it should be appreciated that the networks connecting user nodes, the network connecting a user node and a hub node, and the network connecting a hub node and a managed blockchain may be entirely distinct from one another, or shared only between two connections (e.g., a first network for user node to user node communications and user node to hub node communications, and a second network for hub node to ledger/managed blockchain communications). Accordingly, the system illustrated in FIG. 7A is merely an example system, and is not to limit the spirit and scope of the disclosure herein.

As illustrated, source user node 726A and target user node 726B may be registered with the hub node 734. Additionally, as illustrated, the source user node 726A and target user node 726B are substantively connected. For example, the source user node 726A and target user node 726B may have both previously undergone the hub connection operations, and subsequently node connection process operations, illustrated and described above with respect to FIGS. 5 and 6.

The data flow operations 702-714 illustrated in FIG. 7A are further illustrated in the flow chart depicted by FIG. 7B. The data flow operations 702-714 may be performed by different components within the system, as illustrated in FIG. 7A. For example, as illustrated, the source user node 726A may perform all or part of operations 702, 704, 706, 708, and 712. As illustrated, the target user node 726B may perform all or part of operations 710, and 712. As illustrated, the hub node 734 may perform operation 714.

At block 702, a source user node, such as source user node 726A embodied by a user node apparatus such as the apparatus 300, may include means, such as processor 302, communications circuitry 308, content management circuitry 314, and/or the like, configured to receive a node content request from a target user node, such as the target user node 726B embodied by another apparatus 300. The target user node, for example target user node 726B, include means, such as processor 302, communications circuitry 308, node management circuitry 310, and/or the like, configured to transmit the node content request to the source user node, for example source user node 726A, through a network, for example network 716. In a particular example, the transmitted node content request includes information that uniquely identifies particular node content stored by the source user node, such as a node content identifier. In an example system, the target user node 726B may include means, such as input/output circuitry 306, processor 302, content management circuitry 314, and/or the like, for receiving user input indicating requested node content from the source user node 726A. The node content request may be transmitted in response to receiving the user input, for example via means such as input/output circuitry 306, processor 302, node management circuitry 310, content management circuitry 314, and/or the like.

In some embodiments, the node content request is transmitted indirectly from the target user node to the source user node. For example, the node content request may be generated and/or transmitted from the target user node to the hub node, which may relay the request to the source user node. The hub node may maintain a portion of the information associated with the node content request for generating and/or storing a log of the transfer, for example via a node content transfer report. In other embodiments, the node content request is transmitted directly from the target user node to the source user node.

In the example system illustrated in FIG. 7A, source user node 726A and target user node 726B each include a server, specifically servers 728A and 728B, a database, specifically databases 730A and 730B, and a static file storage, specifically 732A and 732B, which each may include one or more hardware and/or software modules identified above with respect to the apparatus 300. The target user node 726B, utilizing server 728B in conjunction with the database 730B for example, identify a user node identifier associated with source user node 726A, as illustrated UUID: ABC . . . XYZ. The target user node 726B may identify and communicate with source user node 726A utilizing the identified user node identifier. For example, the target user node 726B may utilize the user node identifier to retrieve electronic contact information (e.g., IP address, URI, or other information used to communicate with source user node 726A) associated with the source user node 726A from the database 730B, based on being substantively connected previously to the source user node 726A.

At block 704, the source user node includes means, such as processor 302, node management circuitry 310, and/or the like, to retrieve the requested node content from a source user node content storage. The source user node may, for example, include means to extract data or information, such as a node content identifier, user node metadata associated with the requesting user node (e.g., the target user node 726B), and/or the like, for use in identifying the source user node content storage and/or retrieving the requested node content. In a particular example, at block 704, the source user node may extract at least a node content identifier from the node content request, query a source user node content storage associated with the source user node for node content associated with the extracted node content identifier, and receive result data including the retrieved node content.

In the example system illustrated in FIG. 7A, source user node 726A may receive the node content request utilizing the server 728A, which may include hardware and/or software means as identified above with respect to the apparatus 300. The source user node 726A may then, utilizing the server 728A, extract a node content identifier from the received node content request. The source user node 726A may then identify database 730A as a user node content storage in conjunction with static file storage 732A, and execute a query for the node content associated with the node content identifier extracted earlier. For example, as illustrated, the source user node 726A may retrieve the source node content 718, specifically “CONTENT1” associated with node content identifier UUID: 123 . . . 789. “CONTENT1” may represent, in a particular example, course content including, for example, one or more activities, scheduled assignments, calendar dates, and documents and/or learning materials. It should be appreciated that, in other embodiments, CONTENT1 may include one or more node content types and/or one or more pieces of node content.

In some embodiments, the source node content 718 may further include, or otherwise is associated with, a node content checksum (for example, depicted as a “source content checksum”). The source content checksum may be generated based on one or more properties, metadata, and/or content associated with the node content being transferred. For example, the node content checksum may be generated based on the size of the source node content 718 and/or the data (or a particular encoding of the data) embodied by the source node content 718. For example, where the source node content 718 includes text data, the text data may be used in generating the corresponding node content checksum. Alternatively, where node content includes image data, the image data may be encoded using an encoding format that can then be used in generating the corresponding node content checksum. The source content checksum may be generated using a checksum generation function, for example, one or more iterations of one (or a plurality) of one-way transformation(s). In some embodiments, the node content checksum is generated using a hash function, multiple hash functions, or multiple iterations of one or more hash function(s).

In this regard, where the source content checksum relies on the underlying data of the node content, the checksum represents a unique value that changes as content is edited or otherwise altered. For example, a minor change (e.g., one or a few characters added or removed to text data, addition of new image data, or the like) to source node content 718 may result in an entirely different checksum associated with the changed or edited node content. A receiving user node, or the hub node, may identify that a change occurred from the original node content where the node content checksum for the edited node content no longer matches the node content checksum of the original node content.

In some embodiments, the node content response is transmitted indirectly via the hub node. For example, the source user node may generate and/or transmit the node content response to the hub node, which may relay the response to the target user node. In some embodiments, the hub node may utilize the node content response, or a portion thereof, to generate and/or maintain a node content transfer report that represents a log of the transfer (or rejection of the transfer). In some embodiments, the node content response is transmitted in response to the node content request. In other embodiments, the node content response is transmitted directly from the source user node to the target user node.

At optional block 706, the source user node 726A includes means, such as processor 302, content management circuitry 314, and/or the like, to identify a permission set associated with the node content to be transferred. In a particular example, the source user node may, utilizing means such as processor 302 and/or content management circuitry 314, retrieve, from the user node content storage associated with the source user node, a permission set associated with the retrieved node content. In another example, the retrieved node content may be used to determine, or include an indicator used to determine, a permission set.

At block 708, the source user node includes means, such as processor 302, communications circuitry 308, and/or content management circuitry 314, to transmit a node content response to the target user node. In a particular example, the node content response may duplicate the retrieved node content to include in the node content responses, such that the node content response includes at least a duplicate of the requested node content associated with the identified permission set.

At optional block 710, the target user node, which receives the node content response at block 708 for example, includes means, such as processor 302, content management circuitry 314, and/or the like, to store the node content duplicate in a target user node content storage. In a particular example, the target user node may, utilizing the identified means, generate a second, new node content identifier associated with the node content duplicate included in the node content response, and store the node content duplicate and/or permission set, associated with the new node content identifier.

In the example system illustrated in FIG. 7A, source user node 726A may transmit a node content response including a duplicate of CONTENT1, e.g., “CONTENT1_DUP.” The node content duplicate CONTENT1_DUP includes the same information as CONTENT1. The target user node 726B then may generate a new node content identifier associated with the received node content, specifically UUID: 987 . . . 321 as illustrated. This information, as illustrated, may be embodied by or utilized to generate node content duplicate 720, which target user node 726B may store, for example utilizing server 728A and database 730B.

The node content duplicate 720 is similarly associated with a node content checksum (depicted as “duplicate content checksum”). The target user node 726B may re-generate the duplicate content checksum for the node content duplicate 720 based on the data received from the source user node 726A. If the node content duplicate is the full, unedited or otherwise unchanged version of the source node content 718, the corresponding node content checksums for the source node content 718 and the node content duplicate 720 should match.

The target user node 726B may compare the duplicate content checksum for the node content duplicate 720 to a purported source content checksum for the source node content 718, which may have been received as part of the data transferred from the source user node 726A. To verify the node content duplicate 720 has not been edited from the content that was requested, the target user node 726B may determine whether the comparison indicates the duplicate content checksum for the node content duplicate 720 and the source content checksum for the source node content 718 match, indicating the source node content 718 and node content duplicate 720 include the same content data. In some embodiments, if the checksums do not match, the target user node 726B will reject or otherwise not complete the transfer, and/or not store the received node content duplicate 720.

Additionally or alternatively, the target user node 726B may communicate with a ledger, such as managed blockchain 724, to audit the transfer and edit history of the source node content 718 based on the UUID and/or node content checksum. For example, the target user node 726B may, for example directly, or indirectly via the hub node 734, query the ledger to determine if the node content checksum for the node content duplicate 720 received via the transfer matches a previous node content checksum for the source node content 718 when it was last edited or transferred to the source user node 726A from another user node (not shown). For example, the target user node 726B may query for one or more stored node content generation report(s), node content transfer reports and/or node content edit reports associated with the source node content 718, based on the corresponding node content identifier, and analyze the reports to determine the history of the source node content 718 and identify if fraudulent, unauthorized, or otherwise illegitimate transfers and/or edits of the content have occurred.

For the depicted transfer, the duplicate content checksum for the node content duplicate 720 matches the node content checksum for the source node content 718 (e.g., both are a string, hexadecimal value, or other data type of “2BC . . . 9EA”). In this regard, after optionally confirming through auditing, the target user node 726B can confirm that the received node content (e.g., node content duplicate 720) has not been altered. Similarly, by matching the node content checksum for the node content duplicate 720B, the target user node 726B can confirm that the received node content duplicate 720B is complete, has not been corrupted during transmission over the network 716, and/or otherwise was received intact.

At block 712, the source user node and target user node work together to transmit a node content transfer report, comprising or embodied by a sharing metadata set, to the hub node 734. In some such embodiments, one of the user nodes may identify and/or receive from the other user node the information necessary to transmit the node content transfer report to the hub node 734. Alternatively, in some embodiments, the user each user node may transmit information to the hub node 734, such that the hub node 734 may identify the received information from each user node for use in synthesizing into and/or generating a corresponding node content transfer report, for example using a transfer identifier or session identifier known by both user nodes. For example, the source user node and target user node may each include means, such as processor 302, content management circuitry 314, communications circuitry 308, and/or the like, to transmit to a hub node one or more metadata portions associated with the transferred node content. For example, the source user node may be configured to transmit at least the node content identifier associated with the source node content, and a source user node identifier associated with the source user node, and the target user node may be configured to transmit at least the new node content identifier associated with the node content duplicate stored by the target user node, and a target user node identifier associated with the target user node. Additionally or alternatively, in some embodiments, the source user node 726A or the target user node 726B may be configured to transmit the node content checksum that is shared for the source node content and the node content duplicate. Additionally or alternatively, the source user node 726A may transmit the source content checksum associated with the source node content 718 for storage, and the target user node 726B may transmit the duplicate content checksum associated with the node content duplicate 720, to the hub node 734. In some such embodiments, the hub node 734 include both checksums in a transfer report, or store either in a circumstance where the checksums match. The transmitted metadata portions, identifiers, checksums, and the like may be transmitted associated with a particular transfer identifier, session identifier, and/or the like used to link information transmitted by each distinct user node. For example, in some embodiments, a session identifier, transfer identifier, or the like may be generated by the target user node 726B and transmitted to the source user node 726A along with the original request. In some embodiments, the session identifier, transfer identifier, or the like is generated by the source user node 726A and transmitted to the target user node 726B along with the node content duplicate 720.

In the example system illustrated in FIG. 7A, the sharing metadata may include a source user node identifier associated with the source user node 726A, the source node content identifier associated with the node content retrieved and transmitted by the source user node 726A, a target user node identifier associated with the target user node 726B receiving the transferred node content, a target node content identifier associated with the node content duplicate stored by the target user node 726B, a node content checksum that matches for the source node content 718 and the node content duplicate 720, and a permission set associated with the node content duplicate. The source user node 726A may transmit a portion of the sharing metadata, specifically the data/information under the control of the source user node 726A, such as the source user node identifier associated with the source user node 726A, the source node content identifier associated with the node content retrieved and transmitted by the source user node 726A, and transfer permission. Similarly, the target user node 726B may transmit another portion of the sharing metadata, specifically the data/information under the control of the target user node 726B, such as the target user node identifier associated with the target user node 726B, and the target node content identifier associated with the node content duplicate received and stored by the target user node 726B. In some systems, the target user node 726B may also transmit information related to the permission set associated with the node content duplicate. Additionally or alternatively, in other systems, other data/information may be uniquely transmitted by one or more of the user nodes involved in the node content transfer. For example, in a particular system, the target user node 726B may be configured to receive a source metadata portion from the source user node 726B as part of the transfer, and the target user node 726B may be configured to transmit all of the sharing metadata to the hub node 734.

At block 714, the hub node is caused to store the content transfer report in a node content transfer report leger. For example, the hub node may be embodied by apparatus 200, and may utilize means such as processor 202, content management recording circuitry 214, ledger recording circuitry 222, and/or the like, to combine received sharing metadata into a transfer report. The hub node may also, for example utilizing means such as processor 202, communications circuitry 208, content management recording circuitry 214, ledger recording circuitry 222, and/or the like, to add the transfer report to a ledger, such as a managed blockchain.

In the example system illustrated in FIG. 7A, the hub user node 734 includes server 736, which may include one or more hardware and/or software modules identified above with respect to the apparatus 200. The hub node 734 may utilize the server 736 to generate transfer report 722 utilizing the received sharing metadata, and communicate with managed blockchain 724, such as through network 716. For example, the hub node 734 may add transfer report 722 to the managed blockchain 724 via network 716. In other systems, the hub node 734 may utilize server 736 to request transfer report 722 be added to the managed blockchain 724. For example, managed blockchain 724 may be controlled by a remote or third-party server configured to communicate with hub node 734 utilizing server 736.

FIG. 8A is a block diagram showing an example system and data flow for editing content, such as node content, by a user node (editing user node 824) with attribution and tracing enabled via a hub node (hub node 832), within which embodiments of the present invention may operate. The editing user node 824 may edit node content stored by the editing user node 824, for example in database 828.

In some embodiments, the editing user node 824 may generate and/or create original node content. For example, the editing user node 824 may generate the original node content via one or more tools executed via the editing user node 824. In some embodiments, the generated original node content ma be reported to a hub node to log the generation of the original node content. In some embodiments the editing user node 824 generates and/or transmits a node content generation metadata set to the hub node, for example hub node 832, for logging. The node content generation metadata set may include an identifier associated with the newly generated node content, the editing user node 824 (e.g., a corresponding identifier), and/or associated information. The hub node, for example hub node 832, may generate a node content generation report based on the node content generation metadata set.

The node content generation report may include all information, or a portion of, the node content generation metadata set, and/or additional information, for example a timestamp, auditing information, copyright information, ownership information, or the like. The node content generation report may be stored in a ledger, for example a node content report ledger, embodied by a blockchain storage and/or another database implementation.

Editing user node 824 and hub node 832 are configured to communicate with one another via network 814. Additionally, hub node 832 is also configured to communicate with managed blockchain 822 via network 814. However, it should be appreciated that the network connecting a user node and a hub node, and the network connecting a hub node and a managed blockchain, may be entirely distinct from one another or shared. Accordingly, the system illustrated in FIG. 8A is merely an example system, and is not to limit the spirit and scope of the disclosure herein.

As illustrated, editing user node 824 is registered with the hub node 832, to enable attribution and tracing by communicating with the hub node 832. Thus, editing user node 824 may have previously undergone the hub connection operations illustrated and described above with respect to FIG. 5. However, the semi-autonomous nature of the editing user node 824 allows content editing to be performed, without attribution and tracing, by a user node not registered with a hub node. Accordingly, it should be appreciated that many of the operations illustrated in FIGS. 8A and 8B may be performed by a user node regardless of whether the user node is connected to the hub node and/or other peer user nodes.

The data flow operations 802-812 illustrated in FIG. 8A are further illustrated in the flow chart depicted by FIG. 8B. The data flow operations 802-812 may be performed by different components within the system, as illustrated in FIG. 8A. For example, as illustrated, the editing user node 824 may perform all or part of the illustrated operations, while the hub node 832 may perform some or all of operation 814.

At block 802, the editing user node includes means, such as processor 302, content creation circuitry 312, and/or the like, to retrieve, from a user node content storage, source node content associated with a source node content identifier. In a particular example, the editing user node may retrieve the source node content in response to user input, such as user input received via means such as input/output circuitry 306. The editing user node may identify the source node content identifier associated with the source node content to be edited based on the user input, or other information received. In a particular example, the editing user node may query the associated user node content storage utilizing the source node content identifier, and receive result data including the source node content.

In the example system illustrated in FIG. 8A, editing user node 824 retrieves source node content 816. For example, editing user node 824 may retrieve the source node content 816 from database 828 (or multiple sub-databases thereof), which may be configured to operate, utilizing the means described above with respect to FIG. 3, as a user node content storage. For example, editing user node 824 may receive user input indicating particular node content to be edited, for example a user action that indicates node content associated with a particular node content identifier UUID: 123 . . . 789 should be edited. The editing user node 824 may then query the user node content storage, such as database 828 in conjunction with static file storage 830, to retrieve the source node content 816 to be edited. For example, the editing user node 824 may query for node content associated with the user content identifier UUID: 123 . . . 789, and thus retrieve CONTENT1 as indicated by source node content 816. The source content checksum associated with the source node content 816 may be retrieved as associated with the particular node content identifier UUID: 123 . . . 789. In other embodiments, the editing user node 824 may generate, or otherwise re-calculate, the source content checksum based on the data and/or metadata retrieved source node content 816. For example, the source content checksum for the source node content 816 may be generated by applying the source node content 816 to one or more one-way transformation functions, or one or more iterations thereof. For example, the source content checksum for the source node content 816 may be generated by applying the source node content 816 to a checksum generation function, such as a checksum generation hash function.

At block 804, the editing user node includes means, such as processor 302, content creation circuitry 312, and/or the like, to generate edited node content utilizing source node content. In a particular example, the editing user node may include one or more software modules configured to allow a user to edit the source node content into edited node content, which the editing user node generates and stores upon a save action indicated by user input.

At block 806, the editing user node includes means, such as processor 302, content creation circuitry 312, and/or the like, to generate an edited node content identifier associated with the edited node content. For example, the editing user node may identify a unique node content identifier based on one or more algorithms, or randomization algorithms, to generate an edited node content identifier. Additionally or alternatively, the editing user node may include means, such as processor 302, content creation circuitry 312, and/or the like, to validate that the newly generated edited node content identifier is in fact unique.

In the example system illustrated in FIG. 8A, the editing user node 824 may generate edited node content 818 utilizing source node content 816. For example, editing user node 824 may be configured with software and/or hardware modules that enable the user to change, add, delete, or otherwise edit text, images, and/or the like associated with stored node content, such as utilizing the means identified above with respect to apparatus 300 and embodied by server 826, database 828, and static file storage 830. Accordingly, in the illustrated system, source node content 816 refers to CONTENT1, which may include a set of text, images, resources, and/or the like. CONTENT1, and its corresponding set of text, images, resources, and/or the like, may be edited with a new, altered, deleted, or other set of text, images, resources, and/or the like, to generate edited node content 818, specifically CONTENT1A.

Due to the edits to the content, the edited node content 818 may be associated with a different node content checksum from the source node content 816. In some embodiments, the edits to the source node content change the output generated by the checksum generation function(s). For example, to generate the edited content checksum associated with the edited node content 818, the edited node content 818 may be applied to the checksum generation function. The checksum generation function may be the same checksum generation function used to generate the node content checksum for the source node content 816. The edits to the node content cause the output generated to be different, for example due to changes in the content size, or data embodying the node content. As depicted, for example, the source node content 816 is associated with a node content checksum of “0CA . . . FFF,” while the edited node content 818 is associated with an edited content checksum of “AF5 . . . DC7.” In this regard, the mismatch between the two checksums indicates to the editing user node 824 (as well as any subsequent user nodes and/or the hub node 832) that the two node content data objects do not include the same content data.

At block 808, the editing user node includes means, such as processor 302, content creation circuitry 312, and/or the like, to store, in the user node content storage, the edited node content associated with the edited node content identifier. In a particular example, the editing user node may add the edited node content to the user node content storage such that it may be retrieved utilizing the associated edited node content identifier.

In the example system illustrated in FIG. 8A, editing user node 824 may, utilizing the means identified above with respect to the apparatus 300, store the edited node content 818 utilizing database 828 in conjunction with static file storage 830. For example, editing user node 824 may store the edited node content 818, including resources and/or component parts, in the database 828 and/or static file storage 830 associated with the edited node content identifier UUID: 123 . . . 123. Accordingly, the editing user node 824 may subsequently retrieve the edited node content 818 from the database 828 and/or static file storage 830 utilizing the edited node content identifier. In some embodiments, the editing user node 824 stores the edited node content checksum associated with the source node content 816, for example by storing the edited node content checksum such that it is retrievable based on the edited node content identifier. Additionally or alternatively, in some embodiments, the source content checksum associated with the source node content 816 is stored, for example based on the node content identifier for the source node content 816. By storing one or both of the checksums, the user node may improve efficiency and save processing resources of the user node for retrieving and processing the checksums to provide to the hub node 832. In yet other embodiments, one or neither of the checksum(s) is stored, and the editing user node 824 is configured to re-generate each checksum by retrieving the corresponding node content and applying the retrieved node content to the checksum generation function. By limiting stored information, such embodiments decrease the required data storage requirements for the user node.

As depicted, the node content checksum associated with the source node content 816 may be a string, number, or other data value based on the source node content 816. Similarly, the edited node content checksum associated with the edited node content 818 may be a string, number, or other data value based on the edited node content 818. Each of the source node content checksum and the edited node content checksum may be generated using a checksum generation function. For example, the checksum generation function may generate a node content checksum based on the size, file contents, text, images, or other data associated with node content applied to the checksum generation function. For example, the edits applied to the source node content 816 to create edited node content 818 may result in the different node content checksums. It should be appreciated that even a small change to node content may result in an entirely different node content checksum between the source node content and the edited node content.

At block 810, the editing user node includes means, such as processor 302, content creation circuitry 312, communications circuitry 308, and/or the like, to transmit, to the hub node, a node content edit report. The node content edit report may include, for example, user node metadata, node content metadata, the generated edited node content identifier, or other information associated with the generation of the edited node content, or associated with the edited node content itself.

In the example system illustrated in FIG. 8A, the server 826 may include hardware and/or software means as identified above with respect to the apparatus 300. The server 826 may be configured to generate and/or transmit an edit report, such as edit report 820, including editing metadata associated with the performed editing transaction. Similarly, the server 834 may include hardware and/or software means as identified above with respect to the apparatus 200, configured receive the transmitted edit report, such as edit report 820. For example, the edit report 820 includes the source node identifier, specifically the user node identifier associated with the editing user node 824 that performed the edits (e.g., UUID: ABC . . . XYZ), the source node content identifier (e.g., UUID: 123 . . . 789), the edited node content identifier (e.g., UUID: 123 . . . 123), and the edited node content checksum (e.g., “AFS . . . DC7”). In some embodiments, the edit report 820 may include both the edited node content checksum and the source node content checksum (e.g., “0CA . . . FFF”), In other systems, additional or alternative metadata associated with the editing transaction may be included. For example, the edit report may include a timestamp associated with the edit, a permission set, or the like.

At block 812, the editing user node causes the hub node to store the node content edit report in a node content edit report ledger. In an example system, the hub node incudes means, such as processor 202, content creation recording circuitry 212, ledger recording circuitry 222, and/or the like, for detecting a new node content edit report has been received. Utilizing the same, different, or additional means, the hub node may be configured to add the transfer report to a ledger, such as a managed blockchain. In some systems, the managed blockchain is configured to store both node content transfer reports and node content edit reports, such that a single managed blockchain is configured to function as both a node content transfer report ledger and a node content edit report ledger. In other systems, a node content transfer report ledger may be distinct from a node content edit report ledger, for example, by embodying both ledgers as distinct managed blockchains.

In the example system illustrated in FIG. 8A, the server 834 may include hardware and/or software means as identified above with respect to the apparatus 200 configured to at least communicate with the managed blockchain 822. For example, the server 834 may be configured to add edit report 820 to the managed blockchain 822 via network 814. In some systems, server 834 may be configured to communicate with a remote or third-party server configured to control managed blockchain 822, to request edit report 820 be added to the managed blockchain.

A user node, or the hub node itself, may audit edit reports and/or transfer reports stored via a hub node, for example to a managed blockchain or another ledger, to verify whether node content has been transferred, edited, or otherwise illegitimately utilized by a user node. For example, a user node may transmit to the hub node metadata associated with newly created node content and/or edited node content. A corresponding creation report and/or edit report may be stored associated with the node content. As the node content is transferred from the creator node to another user node, and subsequently between other user nodes, a transfer report may be generated and stored via the hub node for each transfer that includes the checksum that the two user nodes taking part in the transfer agreed upon for the transferred content. Similarly, if any user node further edits the node content, an edit report may be generated and stored via the hub node. Each stored report may be associated with a node content identifier that enables a user node to identify all actions performed associated with the node content, and previous versions of the node content.

The action history of particular node content may be audited at predetermined time intervals, at the request of a user, or during specified actions (e.g., during a node content transfer to determine if the transfer should be completed). For example, upon receiving transferred node content, a user node may identify whether the transferred node content has been edited by generating a node content checksum for the transferred node content, and comparing the checksum to previous node content checksums linked to the transferred node content via various edit reports and/or transfer reports. Similarly, the user node may identify whether a complete attribution chain exists for the transferred node content that spans from initial creation of the transferred node content to the previous transfer. In this regard, for example, the user node may retrieve a transfer report set, creation report set and/or an edit report set associated with the node content identifier for the transferred node content, and compare the node content checksum of each report with the node content checksum for the transferred node content (or compare it with the node content checksum of a previous version, based on one or more edit reports).

The user node may identify based on one or more checksum comparisons and node content identifier comparisons utilizing the transfer report set, creation report set and/or the edit report set, that a transfer report does not exist that indicates how (or a previous version) was received by the previous user node, and thus determine that an illegitimate transfer may have occurred (e.g., a transfer of node content manually performed between two user nodes without reporting to and/or validation by the hub node). For example, if User Node A transfers node content to User Node B directly, and the transfer is not reported to the hub node, the hub node and/or subsequent user nodes cannot determine if the transfer was legitimate based on permission set(s) associated with the node content. Similarly, a user node may identify based on one or more checksum comparisons and node content identifier comparisons utilizing the transfer report set, creation report set and/or the edit report set, that a creation report or edit report does not exist that indicates creation of the transferred node content, and thus determine that an illegitimate edit may have occurred (e.g., an edit of node content performed by a user node but not reported to the hub node), which may violate a permissions set associated with editing the transferred node content. In some embodiments, where the audit report is performed during transfer, the user node may reject or terminate a transfer of node content if the audit process indicates an illegitimate edit or illegitimate transfer occurred. Alternatively, the user node may be configured to notify the user, such as by generating and rendering an alert, of the possibility of an illegitimate edit or illegitimate transfer. Similarly, identifying a missing report in an attribution chain enables a user node and/or hub node (or associated auditing node for example) to identify a user node that caused the break in the attribution chain.

In some embodiments, an administrator user may, via the hub node or an auditing node associated with the hub node, perform the auditing process to identify user nodes that have violated one or more permission set(s), or otherwise are associated with possibly fraudulent activity. The hub node and/or auditing node may perform one or more actions associated with the user nodes identified through the auditing process as associated with fraudulent and/or possibly fraudulent activity. For example, a user node that has violated a permission set may be notified, and/or a second user node (e.g., the user node associated with creation of the node content) may be notified. Additionally or alternatively, the hub node may be updated to store information for identifying the user nodes associated with illegitimate or fraudulent activity, and/or possibly illegitimate or fraudulent activity. The hub node may be configured to reject transfers associated with such user nodes, or generate and transmit a fraudulent user node warning notification to other user nodes in communication with the identified user nodes.

It should be appreciated that the systems described with respect to the figures above are merely example systems in which embodiments of the present disclosure may operate. Additionally, the operations performed by components and/or embodiment apparatuses of the illustrated systems are merely example processes, and in other embodiments other operations and/or processes are performed. Accordingly, embodiments of the present disclosure are not limited in scope and spirit to merely the operations and/or processes described above with respect to the illustrated figures.

### CONCLUSION

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

This listing of the claims replaces all prior listings and versions in the present application:

1. A method of enabling node content management between two user nodes of a user node set with attribution and traceability, the method comprising:
receiving a hub registration request from a first user node of the user node set;
registering the first user node of the user node set to a registered node list;
receiving a second hub registration request from a second user node of the user node set;
registering the second user node of the user node set to the registered node list;
receiving a node connection request from the first user node;
transmitting the node connection request to the second user node;
receiving a node connection response from the second user node;
transmitting the node connection response to the first user node;
generating a node connection report based on the node connection request, the node connection response, or a combination thereof; and
causing storing of the node connection report in a ledger configured to store at least the node connection report.

2. The method of claim 1, further comprising:
receiving a node content request from a target user node associated with a source user node, the node content request associated with requested original node content;
wherein the target user node is the first user node or the second user node, and the target user node is the other of the first user node or the second user node;
relaying the node content request to the source user node;
receiving a node content response from the source user node, wherein the node content response comprises a node content duplicate associated with the requested original node content;
relaying the node content response to the target user node to cause the target user node to store the node content duplicate;
generating a node content transfer report based on the node content request, the node content response, or the combination thereof; and
storing the node content transfer report in the ledger.

3. The method of claim 1, further comprising:
receiving an editing metadata set from the target user node or the source user node, the editing metadata set associated with edited node content generated from source node content;
generating a node content edit report based on at least the editing metadata set; and
storing the node content edit report in the ledger.

4. The method of claim 1, further comprising:
receiving a node content generation metadata set from the target user node or the source user node, the node content generation metadata set associated with new created node content;
generating a node content generation report based on at least the node content generation metadata set; and
storing the node content generation report in the ledger.

5. The method of claim 2, further comprising:
identifying a transferred content checksum associated with the node content duplicate;
identifying a source content checksum associated with the requested original node content; and
determining the transferred content checksum matches the source content checksum by comparing the transferred content checksum and the source content checksum,
wherein relaying the node content response is in response to the determination the transferred content checksum matches the source content checksum.

6. The method of claim 2, further comprising:
retrieving, from the ledger, a node content report set based on the node content request and the node content response, the node content report set comprising a node content generation report set, a node content edit report set, a node content transfer report set, or a combination thereof; and
validating an attribution chain associated with the node content report set is complete,
wherein relaying the node content response is in response to validating the attribution chain.

7. The method of claim 3, further comprising:
retrieving, from the ledger, a node content report set based on the editing metadata set and the node content response, the node content report set comprising a node content generation report set, a node content edit report set, a node content transfer report set, or a combination thereof; and
validating an attribution chain associated with the node content report set is complete,
wherein storing the node content edit report in the ledger is in response to validating the attribution chain.

8. An apparatus for node content management between two user nodes of a user node set with attribution and traceability, the apparatus comprising at least one processor and at least one memory, the at least one memory with computer-coded instructions therein, the computer-coded instructions configured to, in execution with the at least one processor, cause the apparatus to:
receive a hub registration request from a first user node of the user node set;
register the first user node of the user node set to a registered node list;
receive a second hub registration request from a second user node of the user node set;
register the second user node of the user node set to the registered node list;
receive a node connection request from the first user node;
transmit the node connection request to the second user node;
receive a node connection response from the second user node;
transmit the node connection response to the first user node;
generate a node connection report based on the node connection request, the node connection response, or a combination thereof; and
cause storing of the node connection report in a ledger configured to store at least the node connection report.

9. The apparatus of claim 8, further configured to
receive a node content request from a target user node associated with a source user node, the node content request associated with requested original node content;
wherein the target user node is the first user node or the second user node, and the target user node is the other of the first user node or the second user node;
relay the node content request to the source user node;
receive a node content response from the source user node, wherein the node content response comprises a node content duplicate associated with the requested original node content;
relay the node content response to the target user node to cause the target user node to store the node content duplicate;
generate a node content transfer report based on the node content request, the node content response, or the combination thereof; and
store the node content transfer report in the ledger.

10. The apparatus of claim 8, further configured to:
receive an editing metadata set from the target user node or the source user node, the editing metadata set associated with edited node content generated from source node content;
generate a node content edit report based on at least the editing metadata set; and
store the node content edit report in the ledger.

11. The apparatus of claim 8, further configured to:
receive a node content generation metadata set from the target user node or the source user node, the node content generation metadata set associated with new created node content;
generate a node content generation report based on at least the node content generation metadata set; and
store the node content generation report in the ledger.

12. The apparatus of claim 9, further configured to:
identify a transferred content checksum associated with the node content duplicate;
identify a source content checksum associated with the requested original node content; and
determine the transferred content checksum matches the source content checksum by comparing the transferred content checksum and the source content checksum,
wherein the apparatus is configured to relay the node content response in response to the determination the transferred content checksum matches the source content checksum.

13. The apparatus of claim 9, further configured to:
retrieve, from the ledger, a node content report set based on the node content request and the node content response, the node content report set comprising a node content generation report set, a node content edit report set, a node content transfer report set, or a combination thereof; and
validate an attribution chain associated with the node content report set is complete,
wherein the apparatus is configured to relay the node content response is in response to validating the attribution chain.

14. The apparatus of claim 10, further configured to:
retrieve, from the ledger, a node content report set based on the editing metadata set and the node content response, the node content report set comprising a node content generation report set, a node content edit report set, a node content transfer report set, or a combination thereof; and
validate an attribution chain associated with the node content report set is complete,
wherein the apparatus is configured to store the node content edit report in the ledger in response to validating the attribution chain.

15. A computer program product for node content management between two user nodes of a user node set with attribution and traceability, the computer program product comprising at least one non-transitory computer readable storage medium having computer program instructions stored therein, the computer program instructions configured to, when executed by a processor, cause the processor to:
receive a hub registration request from a first user node of the user node set;
register the first user node of the user node set to a registered node list;
receive a second hub registration request from a second user node of the user node set;
register the second user node of the user node set to the registered node list;
receive a node connection request from the first user node;
transmit the node connection request to the second user node;
receive a node connection response from the second user node;
transmit the node connection response to the first user node;
generate a node connection report based on the node connection request, the node connection response, or a combination thereof; and
cause storing of the node connection report in a ledger configured to store at least the node connection report.

16. The computer program product of claim 15, wherein the computer program instructions further cause the processor to:
receive a node content request from a target user node associated with a source user node, the node content request associated with requested original node content;
wherein the target user node is the first user node or the second user node, and the target user node is the other of the first user node or the second user node;
relay the node content request to the source user node;
receive a node content response from the source user node, wherein the node content response comprises a node content duplicate associated with the requested original node content;
relay the node content response to the target user node to cause the target user node to store the node content duplicate;
generate a node content transfer report based on the node content request, the node content response, or the combination thereof; and
store the node content transfer report in the ledger.

17. The computer program product of claim 15, wherein the computer program instructions further cause the processor to:
receive an editing metadata set from the target user node or the source user node, the editing metadata set associated with edited node content generated from source node content;
generate a node content edit report based on at least the editing metadata set; and
store the node content edit report in the ledger.

18. (canceled)

19. The computer program product of claim 16, wherein the computer program instructions further cause the processor to:
identify a transferred content checksum associated with the node content duplicate;
identify a source content checksum associated with the requested original node content; and
determine the transferred content checksum matches the source content checksum by comparing the transferred content checksum and the source content checksum,
wherein the processor is configured to relay the node content response in response to the determination the transferred content checksum matches the source content checksum.

20. The computer program product of claim 16, wherein the computer program instructions further cause the processor to:
retrieve, from the ledger, a node content report set based on the node content request and the node content response, the node content report set comprising a node content generation report set, a node content edit report set, a node content transfer report set, or a combination thereof; and
validate an attribution chain associated with the node content report set is complete,
wherein the processor is configured to relay the node content response is in response to validating the attribution chain.

21. The computer program product of claim 17, wherein the computer program instructions further cause the processor to:
retrieve, from the ledger, a node content report set based on the editing metadata set and the node content response, the node content report set comprising a node content generation report set, a node content edit report set, a node content transfer report set, or a combination thereof; and
validate an attribution chain associated with the node content report set is complete,
wherein the apparatus is configured to store the node content edit report in the ledger in response to validating the attribution chain.

22-36. (canceled)
